(19) United States
(12) Patent Application Publication
(10) Pub. No.: US 2022/0089987 A1
(43) Pub. Date: Mar. 24, 2022

(54) METHOD OF PREPARING REGENERATED SPENT FERMENTED BEVERAGE MEDIA FOR RE-USE IN STABILIZATION AND FILTRATION OF FERMENTED BEVERAGES

(71) Applicant: EP Minerals, LLC, Reno, NV (US)

(72) Inventors: Scott K. Palm, Reno, NV (US); Qun Wang, Reno, NV (US)

(73) Assignee: EP Minerals, LLC, Reno, NV (US)

(21) Appl. No.: 17/538,381

(22) Filed: Nov. 30, 2021

Related U.S. Application Data
(63) Continuation of application No. 15/749,171, filed on Jan. 31, 2018, now abandoned.
(60) Provisional application No. 62/213,473, filed on Sep. 2, 2015.

(51) Int. Cl. C12H 1/07; B01J 20/14; B01J 20/34; B01J 20/10; B01J 20/28; C12H 1/044; A23L 2/38; B01D 41/02; A23L 2/70

(52) U.S. Cl. CPC C12H 1/063; B01J 20/14; B01J 20/3433; B01J 20/345; B01J 20/106; B01J 20/28047; B01J 2220/485; A23L 2/382; B01J 20/3458; B01D 41/02; B01J 20/103; A23L 2/70; B01J 20/28016; C12H 1/0408

(57) ABSTRACT

This disclosure includes regenerated inorganic fermented beverage stabilization and/or clarification media and a process for such regeneration. Inorganic stabilization and clarification media (for processing beer or the like) may include expanded perlite or other expanded natural glasses, diatomaceous earth, silica gel or other precipitated silicas and compositions that incorporate these materials. Such media may be regenerated individually, together in a mixture or together as part of a composite product. The regenerated media meet the requirements for physical and chemical properties for re-use and replacement of the majority of particulate inorganic filtration media and inorganic stabilization media consumed in stabilization and clarification processes, and the related regeneration process provides for substantial benefits to brewers through a reduction of costs to purchase and transport stabilization and clarification media, to dispose of spent cake and/or membrane retentate, while providing for substantial reductions in the introduction of soluble impurities into the fermented beverage.

### CROSS-REFERENCE TO RELATED PATENT APPLICATIONS

This patent application claims the benefit of U.S. Provisional Patent Application No. 62/213,473, filed Sep. 2, 2015.

### TECHNICAL FIELD

The present disclosure relates to stabilization media or stabilization and filtration media used in the processing of fermented liquids, such as beer, and more specifically to the regeneration and re-use of such media.

Beer has traditionally been stabilized and filtered with single-use stabilization and clarification media. The present disclosure concerns the regeneration and re-use of silica stabilization media, and the regeneration and re-use of silica stabilization media and filtration media (e.g., mixtures, composites) and, more specifically, compositions which comprise regenerated beer stabilization media and optionally regenerated diatomite or perlite filtration media.

### BACKGROUND

Beer is produced through a traditional bioprocess in which agricultural products, comprising cereal grains, such as malted barley, rice, maize or wheat and often flavored by hops, are partially converted to alcohol by yeast cells. For the purposes of this disclosure we define fermented beverages as beverages comprising fermented cereal grains. The clarification and stabilization processes in brewing are multi-stage and may involve the removal of most yeast solids and other particles through centrifugation followed by the addition of one or more stabilization media to the beer.

The stabilization media selectively remove either certain proteins or polyphenols, which, if not removed, can react and precipitate under certain temperature conditions. Polyvinylpolypyrrolidone (PVPP), an organic material, and silica gel, an inorganic material, have emerged as the two most popular types of stabilization media for the removal of polyphenols and selected proteins, respectively, from beer. Most of the silica gels used for stabilizing beer are made from neutralizing and gelling aqueous solution of sodium silicate with a mineral acid. After the gel is formed, silica gel is washed to remove soluble substances such as sodium sulfate, and it is then milled to produce a silica hydrogel, containing about 60% total moisture by weight, including free moisture and hydrated water. To produce a product that is commonly called xerogel, hydrogel is dried, usually to a total moisture content of about 10% or less by weight. Some products that have moisture contents between those of hydrogels and xerogels are also used. These products typically contain about 40% total moisture by weight, and are called either silica hydrated xerogel or hydrous gel.

Some silica gel stabilization media contain additives. For example, magnesium silicate may be added for improved stabilization performance and to reduce the soluble iron content of the material (U.S. Pat. Nos. 4,508,742, 4,563,441, 4,797,294 and 5,149,553).

Polish filtration, a term often used to describe the removal of fine solids and semi-solids from beer or wine, usually occurs after the stabilization process in the brewing industry. Suspended media particle filtration, principally using inorganic filtration media (principally diatomaceous earth powders; less commonly, expanded perlite), has been the traditional approach to the polish filtration of beer. In recent years, composite media in which materials suitable for the filtration function and the stabilization function are combined, have been developed. Both organic composite media, containing PVPP (e.g., U.S. Pat. No. 8,420,737), and inorganic composite media, containing silica gel (e.g., U.S. Pat. Nos. 6,712,974 and 8,242,050), have been developed and commercially introduced.

Also in recent years, a reduction in the solids in the liquids filtered in the polish filtration stage in many breweries, as well as improvements in the performance of membrane filters, have allowed crossflow membrane filters to penetrate the polish filtration market. One of the important features of crossflow filtration is that, since it does not employ single-use particulate filtration media, the aggregate amount of spent cake, or retentate, resulting from the crossflow process, which can contain stabilization media and organic wastes, is reduced in mass and volume from the amount of spent cakes produced from traditional diatomaceous earth filtration over a comparable time period.

Several other trends of note in the brewing industry include an increased pressure from regulatory authorities, generally with the agreement and support of the brewing industry, to both reduce the disposal of single-use media in landfills and to improve the purity of beer by reducing soluble elements introduced during the brewing process. There is also interest with some users of diatomite and some government regulatory authorities in the exposure of workers to crystalline silica, which can sometimes lead to lung disease if fine particles containing crystalline silica are inhaled over long periods of time.

There is a need for a process and products that:
1. Reduce the costs of beer (or other fermented beverage) stabilization and filtration;
2. Reduce the mass of waste products generated by the brewing industry;
3. Reduce the introduction of extractable impurities into the beer during the stabilization and filtration processes through contact with processing media; and
4. Reduce the potential exposure of workers to crystalline silica.

The regenerated media and related processes disclosed herein provide all of these benefits.

### Regeneration

As used herein, regeneration (or regenerating spent media, or to regenerate spent media) refers to a process in which spent filtration media or spent stabilization media or mixtures or composites (e.g., stabilizing-filtration media) of these materials are returned to a state in which the materials are similar to the original filtration or stabilization media, or mixtures or composites of these materials, in terms of adsorption potential and filtration performance, including unit consumption, and extractable chemistry.

Regenerated media (or regenerated spent media) refers to filtration media or stabilization media or mixtures or composites of filtration and stabilization media which have been processed following at least one prior use as stabilization and/or filtration media in a fermented beverage (e.g., beer) stabilization or filtration process and have been returned to a state which allows for re-use in a similar process. For example, regenerated silica stabilization media refers to silica stabilization media which have been processed following at least one prior use as stabilization media in a fermented beverage (e.g., beer) stabilization process (or, in some cases, stabilization and filtration process) and have been returned to a state which allows for re-use in a similar process. Similarly, regenerated filtration media refers to filtration media which have been processed following at least one prior use as filtration media in a fermented beverage (e.g., beer) filtration process (or, in some cases, stabilization and filtration process) and have been returned to a state which allows for re-use in a similar process. Likewise, regenerated stabilizing-filtration media refers to stabilizing-filtration media which have been processed following at least one prior use as stabilizing-filtration media in a fermented beverage (e.g., beer) stabilization and filtration process and have been returned to a state which allows for re-use in a similar process.

New media refers to filtration or stabilization media or mixtures or composites of filtration and stabilization media that have been manufactured but not previously used in a stabilization or filtration process.

In the past, a number of attempts have been made to regenerate diatomaceous earth filtration media. In some cases, thermal regeneration processes involving the transportation of the spent filter cake to a central processing facility have been employed. In these processes, the spent material is mixed with spent cake from other facilities to produce a raw material that incorporates blends of diatomite filtration media of various particle size and permeability ranges and chemical compositions with other components of the spent cake that can include organic waste and beer stabilization media, such as silica gel and PVPP, and which is processed to produce a filtration media. However, the successful regeneration of stabilization media contained in spent cake using thermal processes has not been demonstrated, and attempts to regenerate the mixed spent material into a precisely-sized filtration media have failed to produce a product that can fully replace new diatomaceous earth filtration media.

It is known that during manufacturing process, the pore structure of silica stabilization media are modified through the drying and aging processes. For example the pore volume and the surface area are reduced and the pore size changes. As pore structure and volume are of utmost importance to the protein adsorption capability of silica stabilization media, it has been thought that silica stabilization media could not survive an aggressive thermal process in which the proteins and other organic material are oxidized and then regain the media's protein adsorption capability.

A simple concept for wet regeneration includes agitating diatomite spent cake in water to disperse organic matter from diatomite particles. Separation can be carried out by classification using, for example, hydrocyclones, based on differences in particle sizes and specific gravity. Yeast cell debris and other organic matter in diatomite spent cake are mostly a few micrometers in size or smaller and their specific gravities are slightly higher than 1. Particles of diatomite are coarser (up to 100 micrometers) which allows separation in concept. However, diatomite has an effective specific gravity in water not much higher than 1 due to its highly porous structure. Diatomite filter aids, especially the fine grades used in beer polish filtration, have particle size distributions extending to the single micrometer sizes. Separation by mechanical means is not effective and has not been shown to be commercially viable for the regeneration of diatomite spent cake.

Wet chemical and/or biological processes have been attempted to degrade and dissolve the biological and organic matter from diatomite spent cake. Most are based on caustic digestion or washing (EP 0,253,233, EP 1,418,001, U.S. Pat. No. 5,300,234, and US Patent Publication No. 2005/0,051,502) and/or enzymatic digestion (DE 196 25 481, DE 196 52 499, EP 0,611,249 and U.S. Pat. Nos. 5,801,051 and 8,394,279). These wet processes are usually carried out at a warm (40-70° C.) or hot (70-100° C.) temperatures, and other chemicals may be used to enhance the process. For example, surfactant dispersants and oxidizing agents such as sodium hypochlorite, hydrogen peroxide and ozone have been taught. Caustic solution may be used during or after enzymatic digestion, and diluted acid for neutralization after a caustic process. Hydrocyclones, often in small sizes and in multistages, may be used after a chemical and/or enzymatic process to separate regenerated diatomite from residual biological matter and ultrafine particulates. Filters may also be used to recover regenerated diatomite. Some of the wet regeneration methods may also be applicable to perlite, cellulose, synthetic polymeric filter aids and their combinations (e.g., U.S. Pat. No. 5,300,234, EP 0,879,629, and U.S. Pat. No. 8,394,279).

These wet processes suffer in various degrees from high costs in chemicals, enzymes and water; high dewatering costs; and low yields of regenerated diatomite (usually up to 50-70%). It is known that diatom structures are subject to alkali attack in the caustic concentrations commonly used in regenerating spent cakes (0.1-2% NaOH or pH 12.4-13.7), especially at an elevated temperature. Moreover, these regeneration processes do not attempt to recover spent stabilization media, particularly silica gel stabilization media, which are highly soluble at elevated pH levels and are either fully dissolved in the hot caustic digestion or are reduced in size sufficiently due to the dissolution process that recovery downstream is virtually impossible. WO 1999/16531 describes an ambient temperature caustic leaching method for regenerating beer spent cakes containing perlite, and it considers spent diatomite unsuitable for use in this method and spent silica gel non-survivable through the process.

Regenerable PVPP beer stabilization media have been developed and commercially used. The regenerable PVPP stabilization media usually have coarser particle sizes than non-regenerable grades. For example, the single use PVPP product supplied by ISP, Polyclar® 10, has a mean particle size of 25 μm, while the regenerable grade, Polyclar® Super R, has a mean particle size of 110 μm (Brewers' Guardian, May 2000). With regenerable PVPP, the common practice is to inject the stabilization media into beer after the polish filtration stage (with yeast cells already having being removed), and the stabilization media is filtered out in a horizontal leaf filter, a candle filter or a cross-flow membrane filter. Once a filtration cycle is completed, the spent PVPP is regenerated by hot caustic washing in place to break the PVPP-polyphenol bond, followed by hot water wash and dilute acid neutralization. An alternative approach employs several packed columns of PVPP, of which each column performs alternately the task of either beer stabilization or PVPP regeneration to afford a continuous operation. PVPP regeneration may also include enzyme treatment to clean out any yeast debris contained in spent PVPP (US Patent Pub. No. 2013/0,196,025). Beer spent filtration media comprised of expanded perlite and PVPP may be regenerated by caustic washing to recover both perlite and PVPP (WO 1999/16531). This process, however, does not work, according to the inventors of WO 1999/16531, with spent media comprising either diatomite or silica gel or both due to the solubilities of these silica-rich components at elevated levels of pH.

Stabilizing-filtration media are bifunctional and can provide both the stabilization and clarification unit processes for beer and other fermented beverages. They usually are composite materials or contain at least some composite particles that comprise both a filtration component and a stabilization component. For example, in some embodiments, stabilizing-filtration media may comprise: filtration media particulates, and silica stabilizing media deposited onto the filtration media particulates. Celite Cynergy® is an example of a stabilizing-filtration media. In the Celite Cynergy media, the filtration component is diatomite and the stabilizing component is fine precipitated silica gel and precipitated silica (U.S. Pat. No. 6,712,974; US Patent Pub. No. 2009/0,261,041; U.S. Pat. No. 8,242,050). Stabilizing-filtration media for which the filtration component is diatomite and the stabilizing component is silica stabilization media is referred to herein as “modified diatomite” stabilizing-filtration media. Polymeric stabilizing-filtration media are composed of thermoplastic particles for clarification and PVPP, for example, for stabilization.

U.S. Pat. No. 5,484,620 proposes composite stabilizing-filtration media of PVPP and a thermoplastic, formed by thermally co-pressing and sintering at a temperature near the melting points of the thermoplastic (140-260° C.). The process needs to be carried out in an oxygen deprived environment or an inert gas atmosphere due to the poor thermal stability of PVPP in an oxidizing atmosphere. These stabilizing-filtration media can be regenerated by hot caustic washing, optionally by enzyme treatment. Stabilizing-filtration media can also be made by highly cross-linked copolymer of styrene and vinylpyrrolidone (VP) (U.S. Pat. Nos. 6,525,156; 6,733,680; and 6,736,981, and US Patent Pub. Nos.: 2003/0124233; and 2006/0052559) or co-extruded polystyrene (PS) and PVPP (US Patent Pub. Nos.: 2004/0094486; 2005/0145579; 2008/0146739; 2008/0146741; and 2010/0029854). These PS-PVPP stabilizing-filtration media, which form the basis of BASF's Crosspure “filtration and stabilization aid”, can be regenerated following the similar process of regenerating PVPP, i.e., hot caustic washing and enzyme treatment (US Patent Pub. No. 2009/0291164).

In summary, prior art is not known regarding regeneration of: (1) silica stabilization media; (2) stabilizing-filtration media containing silica stabilization media; (3) modified diatomite stabilizing-filtration media containing silica stabilization media (e.g., precipitated silica or silica gel) (4) mixtures or composites comprising silica stabilization media and diatomite, perlite, or rice hull ash filtration media; or (5) mixtures comprising modified diatomite stabilizing-filtration media and diatomite, perlite filtration media or rice hull ash filtration media.

### SUMMARY OF THE DISCLOSURE

In accordance with one aspect of the disclosure, an inorganic product for processing a liquid is disclosed. In one embodiment, the inorganic product may comprise regenerated silica stabilization media, the inorganic product having a Regeneration Efficiency of 45% to 165% or having an Adjusted Regeneration Efficiency of 45% to 165%. In a refinement, the inorganic product may have a Regeneration Efficiency of 50% to 165% or may have an Adjusted Regeneration Efficiency of 50% to 165%. In a further refinement, the inorganic product may have a Regeneration Efficiency of 75% to 165% or may have an Adjusted Regeneration Efficiency of 75% to 165%. In a further refinement, the inorganic product may have a Regeneration Efficiency of 90% to 165% or may have an Adjusted Regeneration Efficiency of 90% to 165%.

In an embodiment, the inorganic product may further comprise regenerated filtration media. In a refinement, the regenerated filtration media may include regenerated diatomite, regenerated perlite, regenerated rice hull ash or combinations thereof. In another refinement, the regenerated silica stabilization media and the regenerated filtration media may be a mixture or a composite.

In any one of the embodiments above, a mass of the regenerated silica stabilization media may be at least about 10% of a total mass of the inorganic product. When used herein in the context of mass, the term “about” means plus or minus 1%. In a refinement, the mass of the regenerated silica stabilization media may be at least about 25% of the total mass of the inorganic product. In a refinement, the mass of the regenerated silica stabilization media may be at least about 50% of the total mass of the inorganic product. In a further refinement, the mass of the regenerated silica stabilization media may be at least about 90% of the mass of the inorganic product. In yet a further refinement, the mass of the regenerated silica stabilization media may be least about 95% of the total mass of the inorganic product. In yet a further refinement, the mass of the regenerated silica stabilization media may be about 100% of the total mass of the inorganic product.

In an embodiment, the inorganic product may further comprise one or more regenerated filtration particulates, wherein the regenerated silica stabilization media and the regenerated filtration particulates are intimately bound, and wherein further, the regenerated filtration particulates and the regenerated silica stabilization media were intimately bound during the original manufacturing process for the inorganic product prior to first use in a stabilization or filtration process. In a refinement, the regenerated filtration particulates may include, or may be, regenerated diatomite, regenerated perlite or regenerated rice hull ash or combinations thereof. In another refinement, the inorganic product may be a regenerated stabilizing-filtration media. In a further refinement, the regenerated stabilizing-filtration media is modified diatomite stabilizing-filtration media or Celite Cynergy.

In any one of the embodiments above the inorganic product may be adapted to produce from a raw beer a first beer filtrate having 50-200% of a turbidity of a second beer filtrate of the raw beer, the second beer filtrate produced by new media having the same composition and used at the same dosage as the inorganic product. The first and second beer filtrates are produced at the same temperature and rate of filtration and at the same or lower rate of pressure increase across a filter cake. The rate of pressure increase above is measured in psig per minute or millibar per minute and turbidity is measured at a temperature of 0° C. In a refinement, the rate of pressure rise during the production of the first beer filtrate is equal to or less than the rate of pressure rise during the production of the second beer filtrate.

In any one of the embodiments above, the regenerated silica stabilization media may be (or may include) a silica xerogel, a hydrated silica xerogel, a silica hydrogel, precipitated silica, a hydrated silica gel, a hydrous silica gel, or the like.

In any one of the embodiments above, the inorganic product may have a specific surface area of at least about 50 m²/g by the BET nitrogen absorption method. When used herein in the context of specific surface area, the term “about” means plus or minus 10 m²/g. In a refinement, the inorganic product may have a specific surface area of at least about 100 m²/g by the BET nitrogen absorption method. In a further refinement, the inorganic product may have a specific surface area of at least about 250 m²/g by the BET nitrogen absorption method.

In any one embodiments above, the inorganic product may have a Loss on Ignition (LOI) of about 5 wt % or less. When used herein in the context of LOI, the term “about” means plus or minus 1%.

In any one of the embodiments above, the inorganic product may have a soluble arsenic content that is less than about 10 ppm as determined by the European Brewery Convention (EBC) Extraction Method. When used herein in the context of soluble arsenic content, the term “about” means herein plus or minus 1 ppm. In a refinement, the inorganic product may have a soluble arsenic content that is less than about 1 ppm as determined by the EBC Extraction Method. In a further refinement, the inorganic product may have a soluble arsenic content that is about 0.1 ppm to about 1 ppm as determined by the EBC Extraction Method. In a further refinement, the inorganic product may have a soluble arsenic content that is about 0.1 ppm to about 0.5 ppm as determined by the EBC Extraction Method.

In any one of the embodiments above, the inorganic product may have a soluble aluminum content that is less than about 120 ppm as determined by the EBC Extraction Method. When used herein in the context of soluble aluminum content, the term “about” means plus or minus 10 ppm. In a refinement, the inorganic product may have a soluble aluminum content that is less than about 30 ppm as determined by the EBC Extraction Method. In a refinement, the inorganic product may have a soluble aluminum content that is between 5 ppm to about 30 ppm as determined by the EBC Extraction Method.

In any one of the embodiments above, the inorganic product may have a soluble iron content that is less than about 80 ppm as determined by the EBC Extraction Method. When used herein in the context of soluble iron content, the term “about” means plus or minus 10 ppm. In a refinement, the inorganic product may have a soluble iron content that is less than about 20 ppm as determined by the EBC Extraction Method. In a refinement, the inorganic product may have a soluble iron content that is between 15 ppm to about 20 ppm as determined by the EBC Extraction Method.

In any one of the embodiments above, the inorganic product may have a crystalline silica content of less than about 0.2% according to the LH Method or by another method that distinguishes cristobalite from non-crystalline phases of silicon dioxide. When used herein in the context of crystalline silica content, the term “about” means plus or minus 0.1%. In a refinement, the inorganic product may have a crystalline silica content of less than about 0.1%. In a refinement, the inorganic product may have a crystalline silica content of 0% or a non-detectable amount.

In any one of the embodiments above, the inorganic product may have a live yeast cell count of less than 10 colony-forming units per gram of media as measured by the APHA MEF Method (as defined herein). In a refinement, the inorganic product may have a live yeast cell count of zero colony-forming units per gram of media as measured by the APHA MEF Method.

In any one of the embodiments above, the inorganic product may have a bacteria count that is less than 10 colony-forming units per gram of media as measured by the USFDA Method for aerobic plate. In a refinement, the inorganic product may have a bacteria count of zero colony-forming units per gram of media as measured by the USFDA Method for aerobic plate.

In any one of the embodiments above, the inorganic product may have a mold count less than 10 colony-forming units per gram of media as measured by the APHA MEF Method. In a refinement, the inorganic product may have a mold count of zero colony-forming units per gram of media as measured by the APHA MEF Method.

In accordance with another aspect of the disclosure, a method of preparing regenerated spent fermented beverage media for re-use in stabilization and optionally filtration of fermented beverages is disclosed. The regenerated spent fermented beverage media includes silica stabilization media. The method may comprise heating the spent fermented beverage media in an oxidizing environment to form regenerated spent fermented beverage media. The spent fermented beverage media may be in the form of spent cake or membrane retentate. The resulting regenerated spent fermented beverage media is suitable for re-use in stabilization and, optionally, filtration of fermented beverages

In an embodiment, the spent fermented beverage media may be dewatered by filtration or centrifugation and dried prior to heating for regeneration.

In an embodiment, the heating may be at a temperature range of about 600° C. to about 800° C. in an oxidizing atmosphere. In another embodiment, the heating may be at a temperature range of about 650° C. to about 750° C. In an embodiment, the heating may occur for a time period of 30 seconds to 1 hour. In an embodiment, the heating may be in the presence of a sufficient amount of oxygen or air to form regenerated media. In an embodiment, the oxidizing atmosphere may be achieved by intimately contacting the spent fermented beverage media being regenerated with air containing oxygen sufficient to fully oxidize organic matter in the spent fermented beverage media. The air may be ambient air or oxygen enriched air. In a refinement, the air, as supplied, may contain 15% to 50% oxygen by volume.

In an embodiment, the spent fermented beverage media may further include an inorganic material other than silica stabilization media. In a refinement, the inorganic material may include, or may be, diatomite, perlite, rice hull ash or combinations thereof.

In any one of the embodiments above, the method may further comprise adding an oxidizing agent to the spent fermented beverage media during the heating. In a refinement, the oxidizing agent may be oxygen enriched air, hydrogen peroxide, ozone, fluorine, chlorine, nitric acid, an alkali nitrate, peroxymonosulfuric acid, peroxydisulfuric acid, an alkali salt of peroxymonosulfuric acid, an alkali salt of peroxydisulfuric acid, an alkali salt of chlorite, alkali salt of chlorate, alkali salt of perchlorate or alkali salt of hypochlorite.

In any one of the embodiments of the method above, the method may further comprise adding new or regenerated stabilization media and optionally new or regenerated filtration media to the regenerated spent fermented beverage media to adjust the stabilization capability of the regenerated spent fermented beverage media, the size exclusion of the regenerated spent fermented beverage media or the permeability of the regenerated spent fermented beverage media.

In any one of the embodiments of the method above, the silica stabilization media may include silica xerogel, silica hydrogel, hydrated silica xerogel or silica hydrous gel.

In any one of the embodiments of the method above, the spent fermented beverage media that is heated for regeneration may be stabilizing-filtration media. In a refinement, the stabilizing-filtration media is modified diatomite stabilizing-filtration media or Celite Cynergy.

In an embodiment, the method may further comprise accumulating spent fermented beverage media; and segregating, prior to the heating, the spent fermented beverage media according to permeability range, stabilization media content or extractable chemistry (e.g., soluble arsenic content, soluble aluminum content, soluble iron content). The method may further comprise storing the spent fermented beverage media prior to regeneration.

In any one of the embodiments of the method above, the regeneration process may take place within the same manufacturing location as the filtration process.

In any one of the embodiments of the method above, the regeneration may take place within a 100 mile radius of the location of the filtration process.

### DETAILED DESCRIPTION

Disclosed herein are regenerated spent media and a method of regenerating such spent media. Disclosed herein are embodiments of regenerated spent media containing silica stabilization media, and a method of regenerating such media spent in the stabilization or the stabilization and clarification of liquids, especially fermented beverages such as beer. The term “media” in this disclosure means one or more medium. Such regenerated silica stabilization media are reusable for the same purpose and have the same, similar or better stabilizing performance as new silica stabilization media. Also disclosed herein is a method of regenerating spent media (resulting from fermented beverage stabilization and clarification) that contains both inorganic filtration media and silica stabilization media (e.g., mixtures or composites of filtration media and silica stabilization media). Such regenerated media is reusable for the same purpose and has the same, similar or better filtration and stabilization performance as comparable new media.

Silica stabilization media disclosed herein may include materials described by common industry practice as silica gels, especially xerogel types. Silica gel adsorbents with similar properties have also sometimes been erroneously described as precipitated silica, and we include any synthetic silicas capable of adsorbing proteins from beer as silica gel for the purposes of this disclosure. Thus, as used herein, silica stabilization media is media that selectively removes certain proteins; such silica stabilization media includes silica gels (e.g., silica xerogels, hydrated silica xerogels, silica hydrogels, hydrated or hydrous silica gels, silica gel adsorbents, precipitated silica gel), precipitated silica, or any synthetic silica capable of adsorbing proteins from beer or other fermented beverages.

To regenerate a spent silica stabilization media, adsorbed organic matter such as proteins need to be removed. Other organic matter, such as yeast cell debris, trapped in the spent silica stabilization media need also to be removed. At the same time, it is essential that silica properties such as pore structure, surface area and surface reactivity be preserved to maintain its stabilization functionality.

Protein removal might conceptually be achieved by desorption such as washing with hot water or diluted acidic or basic solutions. Hot water or dilute acid washing may not be able to effectively remove all adsorbed proteins. Washing with a basic solution tends to partially dissolve silica gel and damage its pore structure and surface reactivity. As a result, the use of a wet process to regenerate silica stabilization media following its use to stabilize beer has not yet been demonstrated.

The inventors of this disclosure have been successful in using a thermal process (thermal treatment in an oxidizing environment to combust proteins and other organic matter) to regenerate silica stabilization media and to regenerate stabilizing-filtration media that includes silica stabilization media (for example, modified diatomite stabilizing-filtration media that includes silica stabilization media) previously used in beer stabilization. The inventors have determined that such a thermal process is effective if the temperature and heat transfer are carefully controlled, as this is necessary to prevent the collapse of the silica pore structure.

As disclosed herein, silica stabilization media or stabilizing-filtration media that includes silica stabilization media (e.g., modified diatomite stabilizing-filtration media that includes silica stabilization media) may be regenerated to a state in which its beer/fermented beverage stabilization effectiveness is essentially restored by heating at a temperature between about 600° C. to about 800° C. in an oxidizing environment for an appropriate period of time. When used herein in the context of a temperature for heating spent fermented beverage media to form regenerated media, the term “about” means plus or minus 10° C. An oxidizing environment herein means sufficient chemical driving force for completely breaking down molecular structures of proteins and other organic matter present in the spent media by oxidation reactions of these organic contaminants so that they form volatile gases, preferably of their highest oxidation states. This may be achieved by supplying sufficient oxygen during the regeneration process in excess of the amount required to react with all organic matter present to form volatile gases, preferably of highest oxidation states. The means of supplying a sufficient amount of oxygen may include intimately contacting the spent media with air during regeneration, supplying fresh air during regeneration and supplying oxygen enriched air during regeneration. This may also be achieved by the addition of one or more other types of oxidizing agents, in place of or in addition to oxygen (although the addition of oxidizing agents may not be necessary when a sufficient amount of oxygen is present).

The oxidizing reaction is enabled and enhanced, both thermodynamically and kinetically, by heating. The heating may be at a temperature between about 600° C. to about 800° C. In another embodiment, the heating may be at a temperature between about 650° C. to about 750° C. In yet another embodiment, the heating may be at a temperature between about 690° C. to about 710° C. Reduced temperatures (e.g., less than about 600° C.) tend to cause insufficient removal of organic matter from spent silica stabilization media while excessive temperatures (e.g., more than about 800° C.) tend to cause collapsing of the pore structure of the silica stabilization media. The time needed to complete the oxidation reactions depends on both the temperature and the oxidation environment. In one embodiment, the time period for heating was 30 seconds to an hour. In another embodiment, the time period for heating was 30 seconds to 30 minutes. In yet another embodiment, in which the heating temperature was about 690° C. to about 710° C., the heating time period was 1 minute to 30 minutes. In some embodiments, the heating was conducted at an elevation of about 1370 meters where the nominal atmospheric pressure is about 645 mmHg or about 85% of that at the sea level. When used herein in the context of elevation, the term “about” means plus or minus 50 meters.

Disclosed herein is a process for thermal regeneration of spent media from beer/fermented beverage stabilization (or stabilization and filtration or stabilizing-filtration). The spent media may be in the form of spent cake and/or (membrane) retentate, or the like. The spent media may include silica stabilization media, or mixtures or composites of silica stabilization media and filtration media. While the detailed description herein is made with reference to the regeneration of spent media from beer stabilization (or stabilization and filtration), the teachings of this disclosure may be employed with spent media from the stabilization (or stabilization and filtration or stabilizing-filtration) of other fermented liquids/beverages.

In an embodiment of the method disclosed herein, (beer) spent media containing inorganic silica stabilization media or containing (a mixture of or composites of) inorganic silica stabilization media and inorganic filtration media may be thermally regenerated by calcination in an oxidizing environment at about 600° C. to about 800° C. In some embodiments, but not necessarily all embodiments, an oxidizing agent in addition to oxygen may be used. The regenerated spent media obtained by the process disclosed herein has a beer stabilization (or stabilization and filtration or stabilizing-filtration) performance similar to corresponding new media.

In one embodiment, the method may further include adding an oxidizing agent to the spent fermented beverage media before calcination or during calcination. In a refinement, the oxidizing agent may be hydrogen peroxide, ozone, fluorine, chlorine, nitric acid, an alkali nitrate, peroxymonosulfuric acid, peroxydisulfuric acid, an alkali salt of peroxymonosulfuric acid, an alkali salt of peroxydisulfuric acid, an alkali salt of chlorite, alkali salt of chlorate, alkali salt of perchlorate or alkali salt of hypochlorite.

In an embodiment, the method may further comprise washing with an acid the spent fermented beverage media prior to calcination. In an embodiment, the method may further comprise washing with an acid the regenerated media after calcination. In a refinement of the above, the acid may be a mineral acid, an organic acid or a mixture thereof. In a further refinement, the mineral acid may be sulfuric acid, hydrochloric acid or a mixture thereof. In another refinement, the organic acid may be acetic or citric acid or a mixture thereof.

In another aspect, a method of processing a fermented liquid is disclosed. The method may comprise mixing the fermented liquid with a mixture that includes regenerated silica stabilization media or a regenerated (blend/mix of or composite of) silica stabilization media and filtration media, and separating the mixture from the liquid through centrifugation, particle filtration or membrane filtration. The method may further comprise adding prior to separating the mixture from the fermented liquid: (1) new stabilization media; (2) new filtration media; (3) new stabilizing-filtration media; or (4) new stabilization and new filtration media to the mixture.

Products regenerable by the teachings of the present disclosure may include inorganic filtration media, silica stabilization media and their mixtures or composites. Such inorganic filtration media may include diatomite, expanded perlite, rice hull ash, their blends or composites of these materials. The diatomite that is regenerated may be natural, straight calcined or flux-calcined.

A composite herein is a particulate material that may comprise at least one individual particle that is further comprised of at least two smaller, non-homogeneous particles intimately bound through adhesion, sintering or fusion. A composite may also be a particulate material onto which another material is coated or deposited. For example, modified diatomite stabilizing-filtration media (both stabilizes and filters) includes composites containing silica stabilization media (e.g., composites containing silica adsorbents). In some embodiments, modified diatomite stabilizing-filtration media may be comprised of filtration media particulates (diatomite particulates) that are coated or deposited with silica stabilization media. These two materials may be so intimately bound together that they may not be separately observable under some levels of magnification, however the resulting effect (of the combination of these materials) on the surface area of the particulates of the stabilizing-filtration media is observable. As noted earlier, one example of a modified diatomite stabilizing-filtration media is Celite Cynergy®. Stabilizing-filtration media is also regenerable by the methods taught herein. Regenerated silica stabilization media may include various types of silica gel (e.g., silica xerogel, hydrated silica xerogel, silica hydrogel, hydrated or hydrous silica gel, silica gel adsorbent, precipitated silica gel), precipitated silica or any synthetic silica used for stabilizing beer or other fermented liquid beverages.

The regenerated silica stabilization media, the regenerated stabilizing-filtration media, and regenerated mixtures of filtration and stabilization media are tested for beer stabilizing capability in comparison with the corresponding new media (silica stabilization media, stabilizing-filtration media, or mixture of filtration and silica stabilization media). In each test cited in the examples, a sample of silica stabilization media, stabilizing-filtration media or mixture of filtration and stabilization media was mixed with 50-ml of a untreated (not yet stabilized) beer in a centrifuge tube in an ice-bath shaker for 30 minutes, followed by centrifugation then filtering through a #1 filter paper under vacuum. The treated and filtered beer was analyzed for alcohol chill haze (ACH) to characterize stability following the European Brewery Convention (EBC) method, as described in EBC Analytica 9.41—Alcohol Chill Haze in Beer. A 30-ml sample of the treated and filtered beer was collected in a turbidity cell, added and mixed with 0.9 ml dehydrated ethanol, and chilled at −5±0.1° C. for 40 minutes in an Isotemp™ II Recirculating Chiller (Fisher Scientific). The chilled beer sample was measured for turbidity (haze) immediately afterwards using a Hach® Ratio/XR Turbidimeter, reported in nephelometric turbidity units (ntu). A blank sample of the same beer (without the addition of stabilization media, stabilizing-filtration media, or filtration and stabilization media) was treated through the same process at the same time and was also measured for its alcohol chill haze, which was used as a baseline for determining the stabilization effectiveness of the media being tested in the term of the percentage reduction in alcohol chill haze. A percentage alcohol chill haze reduction (ACHR) is calculated by dividing the alcohol chill haze of a stabilized beer by the alcohol chill haze of the blank beer.

ACHR (%)=(1−ACH_{Stabilized}/ACH_{Blank})*100, [1]

where ACH_{Stabilized} and ACH_{Blank} are alcohol chill haze of stabilized and blank beers, respectively. A higher ACHR indicates a better performance of a beer stabilization medium. When characterizing a regenerated stabilization medium or a regenerated stabilizing-filtration medium or a mixture of regenerated stabilization and filtration media, a percentage Regeneration Efficiency (RE) is calculated as follows by dividing the ACHR of the regenerated media stabilized beer, ACHR_{Reg′d}, by a benchmark ACHR, ACHR_{BM}. An RE of 100% indicates a full regeneration of the stabilization media.

RE (%)=ACHR_{Reg′d}/ACHR_{BM}*100. [2]

The benchmark ACHR is obtained by stabilizing the same beer under identical conditions with the new media from which the regenerated media are produced. Since thermal treatment usually changes and mostly reduces the volatile constituents of silica gel stabilization media, and the regenerated media usually have lower loss on ignitions (LOIs) than the combined LOIs of their respective new media constituents. A concept of “silica gel equivalency” is introduced to allow benchmarking on the same silica (SiO₂) mass basis. The “silica gel equivalent” mass or dosage of a regenerated silica stabilization medium is calculated by factoring in the LOIs of the new and regenerated media, i.e.,

M_{Stab.Equiv.}=M_{Reg′d}*(1−LOI_{Reg′d})/(1−LOI_{Stab}). [3]

For example, a regenerated silica stabilization medium with 0.2% LOI is regenerated from a spent silica xerogel having 13% LOI prior to use. For the regenerated medium at an actual mass dosage of 1.00 g/L, its equivalent mass dosage of the new silica xerogel is 1.00*(1−0.002)/(1−0.13)=1.15 g/L.

Similar equivalency calculations for both stabilization media and filtration media are applicable to regenerated media comprising both media.

$$\begin{matrix}\begin{matrix}{M}_{Stab . equiv} = {M}_{Reg ' d} \frac{( 1 - {LOI}_{Reg ' d} )}{( 1 - {LOI}_{Stab} )} \\ \frac{{W}_{Cake . Stab} ( 1 - {LOI}_{Stab} )}{{W}_{Cake . Stab} ( 1 - {LOI}_{Stab} ) + {W}_{Cake . Filt} ( 1 - {LOI}_{Filt} )} \\ = {M}_{Reg ' d} \frac{{W}_{Cake . Stab} ( 1 - {LOI}_{Reg ' d} )}{{W}_{Cake . Stab} ( 1 - {LOI}_{Stab} ) + {W}_{Cake . Filt} ( 1 - {LOI}_{Filt} )} ,\end{matrix} \\ and & [ 4 ] \\ \begin{matrix}{M}_{Filt . equiv} = {M}_{Reg ' d} \frac{( 1 - {LOI}_{Reg ' d} )}{( 1 - {LOI}_{Filt} )} \\ \frac{{W}_{Cake . Filt} ( 1 - {LOI}_{Filt} )}{{W}_{Cake . Stab} ( 1 - {LOI}_{Stab} ) + {W}_{Cake . Filt} ( 1 - {LOI}_{Filt} )} \\ = {M}_{Reg ' d} \frac{{W}_{Cake . Stab} ( 1 - {LOI}_{Reg ' d} )}{{W}_{Cake . Stab} ( 1 - {LOI}_{Stab} ) + {W}_{Cake . Filt} ( 1 - {LOI}_{Filt} )} ,\end{matrix} & [ 5 ]\end{matrix}$$

In Equations [3-5], M_{Stab.equiv} and M_{Filt.equiv} are respectively equivalent mass dosages of stabilization media and filtration media of single component or multi-component media. LOI_{Stab}, LOI_{Filt} and LOI_{Reg′d} are loss on ignitions of new stabilization media, new filtration media and regenerated media, respectively; W_{Cake.Stab} and W_{Cake.Filt} are mass contents of the stabilization media and filtration media in the spent cake and M_{Reg′d} actual mass dosage of the regenerated media, respectively.

In the event that the equivalent dosage of a stabilization component in regenerated media is slightly different than the dosage of the new media (mostly due to LOI differentials). Equation [2] is modified to factored in the dosages to calculated an Adjusted Regeneration Efficiency (ARE), i.e.

ARE (%)=ACHR_{Reg′d}/ACHR_{BM}*(M_{BM}/M_{Stab.Equiv})*100, [6]

where M_{BM} and M_{Stab.Equiv} are respective mass dosages of the stabilization media in the benchmark test and its equivalent in the regenerated media test.

Regenerated silica stabilization and filtration media comprising inorganic filtration media and silica stabilization media are characterized by their filtration and stabilization performance against respective new media. In the examples, a small bench scale pressure filter was used for beer stabilization-filtration tests. It had a vertical cylindrical filter chamber of 1⅝ inch (41.3 mm) inside diameter and 2.5 inch (63.5 mm) height and a horizontal septum. A reverse plain Dutch weave wire mesh screen of 128×36 mesh (PZ80) was used as the septum in the examples. Before starting a filtration test, the septum was precoated with slurry of filtration or stabilization and filtration media in clean water by recirculation though the filter. A beer to be stabilized and filtered was cooled down to 1-2° C. in an ice-bath, and the stabilization and filtration media were added to and mixed in the beer with agitation for 30 minutes. The conditioned beer in the ice-bath was then fed to the filter at a desired constant flow rate by a peristaltic pump. Temperature of the beer feed, pressure in the filter chamber, and filtrate turbidity were monitored throughout the test. The stabilized and filtered beer was analyzed for clarity at 0° C. by a Hach Ratio/XR Turbidimeter in nephelometric turbidity units (ntu) and the alcohol chill haze following the EBC procedure (EBC Analytica 9.41—Alcohol Chill Haze in Beer) described above.

Beer filtration capability of the regenerated media may be characterized by a comparison between the turbidity of a first filtrate that results from filtering a raw beer with the regenerated media and the turbidity of a second filtrate that results from filtering the same raw beer under the same conditions (temperature and filtration rate) with new media (of the same composition as the regenerated media) at the same dosage. The turbidity of the first and second filtrates was measured at 0° C. using a ratio turbidity meter. The rates of pressure increase are measured in psig per minute or millibar per minute during both filtration tests and compared against each other. The inventors have found that the turbidity of the beer filtrates produced using the regenerated media is 50-200% of the turbidity of beer filtrates produced using new media having the same composition as the regenerated media.

Regenerated stabilization and filtration media in the examples were also analyzed for other properties. New and regenerated silica stabilization media were characterized by their Loss on ignition (LOI) was determined by heating in a muffle furnace at 1800° F. (982° C.) for 60 minutes. For samples containing free moisture, the LOI measurement also included loss on drying. Specific surface areas as determined by the nitrogen adsorption method based on the Brunauer-Emmett-Teller (BET) theory. In order not to induce pore structure collapse, sample preparation for surface area measurement for samples containing greater than 20% LOI were soaked in methanol for 2 hours, dried at 70° C. overnight and degassed at 110° C. for 2 hours with nitrogen gas purging. Otherwise, samples were dried at 120° C. overnight and then degassed with nitrogen purging at 150° C. for 2 hours. Permeability and wet bulk density (WBD) were determined using an EP Permeameter, for which the concept and basic design are described in U.S. Pat. No. 5,878,374. The solubilities of arsenic, aluminum and iron were determined by following the extraction method of EBC Analytica 10.6 (the “EBC Extraction Method”), in which a powder sample is stirred in a 1 wt % aqueous solution of potassium phthalate, in a solid to liquid ratio of 2.5:100, for 2 hours at the ambient temperature followed by filtering the slurry through a paper filter. The concentration of the target elements in the filtrates were analyzed by the inductively coupled plasma spectrometry (ICP) and graphite furnace atomic absorption spectroscopy (GFAA).

### Example 1

Britesorb® D300 is a silica xerogel beer stabilization media from PQ Corporation. It contains silica xerogel and about 1.2 wt % magnesium according to the manufacturer. The sample used in this disclosure was determined to have about 13% LOI and a specific surface area of 298 m²/g. It was heated at various temperatures in a muffle furnace for 30 or 60 minutes. The mass loss on heating during the process and specific surface area of the thermally treated samples were determined and are listed in Table I. It can be seen that the major dehydration of this silica (xerogel) stabilization media occurred at temperatures of 1300° F. (704° C.) and lower, however, significant loss in surface area after heating for 30 minutes occurred at temperatures 1400° F. (760° C.) and higher. This indicates that at temperatures around or below 1300° F. (704° C.) the xerogel's pore structure and surface area can be mostly preserved.

TABLE I
Thermal Stability of Silica (Xerogel) Stabilization Media Britesorb ® D300

| | | | | | | | | | | |
|---|---|---|---|---|---|---|---|---|---|---|
| Heating | ° F. | 220 | 1000 | 1200 | 1300 | 1400 | 1500 | 1600 | 1750 | 1800 |
| temperature | ° C. | 104 | 538 | 649 | 704 | 760 | 816 | 871 | 954 | 982 |
| and time | min | 60 | 30 | 30 | 30 | 30 | 30 | 30 | 30 | 60 |

| | | | | | | | | | |
|---|---|---|---|---|---|---|---|---|---|
| Mass loss, % | 6.3 | 10.7 | 10.4 | 12.4 | 12.6 | 12.7 | 13.4 | 13.6 | 12.9 |
| Surface area, m²/g | 298 | 299 | 301 | 294 | 200 | 163 | 81 | 17 | n/a |

### Example 2

The thermally-treated silica (xerogel) stabilization media samples from Example 1 were tested for their effectiveness in stabilizing a filtered but untreated (not stabilized) laboratory-brewed ale by mixing in an ice-bath shaker for 30 minutes. The silica (xerogel) stabilization media dosage was 1.0 g/L Britesorb® D300 or equivalent, i.e., the actual dosages of the thermally treated samples were adjusted for the mass loss on heating. The stabilized beer samples were analyzed for the EBC alcohol chill haze, and the results are listed in Table II. After heating at 1200 or 1300° F. (649 or 704° C.) for 30 minutes, the silica (xerogel) stabilization media performed almost or fully as well as new Britesorb® D300 for stabilizing the beer, as indicated by the 94 or 100% Regeneration Efficiency.

TABLE II
Laboratory-brewed Ale Stabilization by Thermally Treated
Britesorb ® D300

| | | Blank | Britesorb ® | Heated silica (xerogel) | |
|---|---|---|---|---|---|
| Test | | beer | D300 | stabilization media | |
| Heated @ | ° F. | N/A | N/A | 1200 | 1300 |
| | ° C. | | | 649 | 704 |

| | | | | |
|---|---|---|---|---|
| Alcohol chill haze, ntu | 603 | 177 | 196 | 176 |
| ACHR, % | 0 | 71 | 67 | 71 |
| Regeneration Eff., % | N/A | N/A | 94 | 100 |

### Example 3

A sample of Britesorb® D300 was used to treat a filtered but untreated (not stabilized) laboratory-brewed ale (16 ntu at ambient temperature) at 1.0 g/L in an ice-bath by shaking for 30 minutes. The treated beer was centrifuged and the sediment was collected and dried in an oven to form a spent silica stabilization medium (in this Example 3, a “spent silica xerogel”). The spent silica xerogel was regenerated by heating in a muffle furnace for 30 minutes, optionally with the presence hydrogen peroxide (added as a 35% solution). The resulting regenerated silica (xerogel) stabilization medium was tested for beer stabilization at 1.0 g/L Britesorb® D300 equivalent by mixing in an ice-bath shaker for 30 minutes (Table III). The silica (xerogel) stabilization medium regenerated at 1300° F. (704° C.) performed as well as new Britesorb® D300 for stabilizing the beer, as indicated by the 99% Regeneration Efficiency. The addition of hydrogen peroxide further enhanced the performance and increased the Regeneration Efficiency to 107%. Those regenerated at lower temperatures, with the presence of hydrogen peroxide, had lower but higher than 75% Regeneration Efficiency.

TABLE III
Laboratory-brewed Ale Stabilizadon by Regenerated
Britesorb ® D300

| | | Blank | Britesorb ® | Regenerated Silica (xerogel) | | | | |
|---|---|---|---|---|---|---|---|---|
| Test | | beer | D300 | Stabilization Medium | | | | |
| Heated @ | ° F. | N/A | N/A | 1300 | 1300 | 1200 | 1100 | 1000 |
| | ° C. | | | 704 | 704 | 649 | 593 | 538 |

| | | | | | | | |
|---|---|---|---|---|---|---|---|
| H₂O₂, g/g | N/A | N/A | 0 | 0.7 | 1.2 | 1.8 | 1.8 |
| xerogel | | | | | | | |
| ACH, ntu | 390 | 102 | 105 | 82 | 150 | 160 | 170 |
| ACHR, % | 0 | 74 | 73 | 79 | 62 | 59 | 56 |
| Reg. Eff., % | N/A | N/A | 99 | 107 | 83 | 80 | 76 |

### Example 4

A lager beer was obtained from a commercial brewery. The beer had passed through the primary filtration stage but not through the stabilization and polish filtration unit processes. Britesorb® D300 was added to the beer at 1.0 g/L and mixing was carried out in an ice-bath shaker for 30 minutes. The treated beer was centrifuged and the sediment was collected and dried in oven to form a spent silica stabilization medium (in this Example 4, a “spent silica xerogel”. The spent silica xerogel was regenerated by heating in a muffle furnace at 1300° F. (704° C.) for 30 minutes. The resulting regenerated silica (xerogel) stabilization medium was tested for stabilization effectiveness in the same lager beer against new Britesorb® D300 at various addition rates (Table IV). The regenerated silica (xerogel) stabilization medium worked as well as the new silica (xerogel) stabilization medium in stabilizing the lager beer.

TABLE IV
Stabilization of Commercial Lager by Regenerated Britesorb ® D300

| | Blank | | | | | | Regen- |
|---|---|---|---|---|---|---|---|
| Test | beer | Britesorb ® D300 | | | | | erated |
| Xerogel, g/L equiv. | 0 | 0.20 | 0.40 | 0.60 | 0.80 | 1.00 | 1.00 |
| Alcohol chill- | 146 | 70 | 63 | 55 | 50 | 44 | 43 |
| haze, ntu | | | | | | | |
| ACHR, % | 0 | 52 | 57 | 62 | 66 | 70 | 71 |
| Reg. Eff., % | N/A | N/A | N/A | N/A | N/A | N/A | 101 |

### Example 5

This example demonstrates regeneration of another silica stabilization media, Daraclar® 1015 from W.R. Grace & Co. This silica stabilization medium is a silica xerogel. A sample used in this disclosure was determined to have about 5% LOI and a specific surface area of 336 m²/g. A 0.50-g sample of the silica (xerogel) stabilization medium, Daraclar® 1015, was mixed with 500 ml of an unstabilized and unfiltered commercial Belgian tripel of 150 ntu (at 5° C.) for 30 minutes, and the spent silica (xerogel) stabilization medium was recovered by centrifugation and vacuum filtration. The treated beer was filtered through a No. 1 filter paper by vacuum. The treated beer was determined to have an EBC alcohol chill haze of 36 ntu vs 134 ntu of the untreated beer (also centrifuged and filtered the same way).

The spent silica (xerogel) stabilization medium was dried at 110° C. for 2 hours, dispersed through a 100 mesh sieve, and regenerated by heating in a muffle furnace at either 1200 or 1300° F. (649 or 304° C.) for 20 to 40 minutes. The regenerated silica (xerogel) stabilization medium samples were tested for stabilization effectiveness in the same Belgian tripel against new Daraclar® 1015 at a dosage of, adjusted for LOI differences, 1.0 g/L Daraclar® 1015 equivalent. Stabilization was carried out by mixing the silica stabilization media in beer for 30 minutes in an ice bath shaker. The treated beer samples were centrifuged, filtered through #1 filter paper under vacuum and characterized for EBC alcohol chill haze. The test results are listed in Table V. It can be seen that the regenerated silica (xerogel) stabilization medium samples performed as well as or slightly better than new Daraclar® 1015 in stabilizing the Belgian tripel, and in this case the lower temperature (1200° F. or 649° C.) and shorter heating time (20 min.) provided for higher Regeneration Efficiency.

TABLE V
Belgian Tripel Stabilizadon with Regenerated Daraclar ® 1015 Xerogel

| | | Blank | Daraclar ® | Regenerated Silica (Xerogel) | | | | |
|---|---|---|---|---|---|---|---|---|
| Test | | beer | 1015 | Stabilization Media | | | | |
| Heating | °F. | N/A | N/A | 1200 | 1200 | 1200 | 1300 | 1300 |
| | °C. | | | 649 | 649 | 649 | 704 | 704 |
| | min | | | 20 | 30 | 40 | 20 | 30 |

| | | | | | | | |
|---|---|---|---|---|---|---|---|
| ACH, ntu | 110 | 32 | 20 | 21 | 24 | 25 | 28 |
| ACHR, % | 0 | 74 | 81 | 81 | 78 | 77 | 75 |
| Regeneration | N/A | N/A | 114 | 113 | 109 | 108 | 104 |
| Eff., % | | | | | | | |

### Example 6

Becosorb® 2500 is a silica stabilization medium that is a hydrated silica xerogel from Eaton Corp. A sample of the product was determined to have 41% LOI and a specific surface area of 282 m²/g. It was tested for stabilization effectiveness in a commercial dark pale ale that had not yet been stabilized or filtered and which had a turbidity of 83 ntu at 5° C. A 0.20-g sample of the Becosorb® 2500 silica stabilization medium was mixed with 100 ml of the beer in an ice-bath shaker for 30 minutes, and the spent silica stabilization medium was recovered by centrifugation and vacuum filtration through a 0.45-μ membrane. The spent silica stabilization medium was dried at 120° C. for 4.5 hours and then regenerated by heating in a muffle furnace at 1300° F. (304° C.) for 30 minutes. The regenerated silica (hydrated xerogel) stabilization medium was tested for stabilization effectiveness in the same dark pale ale against new Becosorb® 2500 at a dosage of, adjusted for LOI differences, 0.84 g/L Becosorb® 2500 equivalent, under otherwise the same conditions and following the same procedure as described above. The blank beer had an EBC alcohol chill haze of 240 ntu, and the beers treated with new and the regenerated silica (hydrated xerogel) stabilization medium had 154 and 157 ntu ACH or 66 and 64% ACHR, respectively. This demonstrates a Regeneration Efficiency of 97%.

### Example 7

Daraclar® 920, from W.R. Grace & Co., is a silica stabilization media that is a silica hydrogel. A sample of the product was determined to have 63% LOI and a specific surface area of 1074 m²/g. It was tested for stabilization effectiveness in a commercial dark pale ale that had not been stabilized or filtered, which had a turbidity of 83 ntu at 5° C. A 0.20-g sample of the Daraclar® 920 was mixed with 100 ml of the beer for 30 minutes in an ice-bath shaker and the spent silica (hydrogel) stabilization media was recovered by centrifugation and vacuum filtration through a 0.45-μ membrane. The spent silica (hydrogel) stabilization media was dried at 120° C. for 4.5 hours and then regenerated by heating in a muffle furnace at 1300° F. (304° C.) for 30 minutes. The regenerated silica (hydrogel) stabilization media was tested for stabilization effectiveness in the same dark pale ale against new Daraclar® 920 at a dosage of, adjusted for LOI differences, 0.84 g/L Daraclar® 920 equivalent, under otherwise the same conditions and following the same procedure as described above. The blank beer had an EBC alcohol chill haze of 240 ntu, and the beers treated with new and the regenerated silica (hydrogel) stabilization media had 186 and 208 ntu ACH or 35 and 19% ACHR, respectively. This demonstrates a Regeneration Efficiency of 55%.

### Example 8

This example demonstrates the beer stabilization performance of a mixture comprising silica stabilization media and diatomite filtration media, in which such mixture had been regenerated from a beer spent cake comprising straight calcined diatomite (filtration media) and silica xerogel (silica stabilization media). The spent cake was generated by stabilization and filtration of 2.5 liter of a laboratory-brewed ale using a bench scale pressure filter. It contained 1.00 g of Celatom® FP-3, a straight calcined diatomite filtration media, as filtration precoat and 2.50 g each of Celatom® FP-3 and Britesorb® D300 as body-feed. Therefore, the spent cake had a silica xerogel to diatomite ratio of 1:1.4 by weight. The spent cake was dried in oven overnight at 110° C., and the dried spent cake had an LOI of 17.6%. It was dispersed through a 100-mesh screen and heated at 1300° F. (704° C.) for 30 minutes for regeneration. The regenerated media had 3.8% LOI and about 0.43 g/g or about 43 wt % Britesorb® D300 equivalent silica xerogel. It was tested for stabilization effectiveness in a laboratory-brewed ale against a benchmark of 1:1 mixture of Britesorb® D300 and Celatom® FP-3 (Table VI). The regenerated media, at silica xerogel dosage 5% below the benchmark, worked similarly as the mixture of new silica xerogel and diatomite in stabilizing the beer.

TABLE VI
Laboratory-brewed Ale Stabilization by Regenerated Silica Xerogel and Diatomite

| | Media, g/L | | | | Stabilization | | |
|---|---|---|---|---|---|---|---|
| | Britesorb ® | Celatom ® | | D300 | ACH | ACHR | ARE |
| Test | D300 | FP-3 | Regenerated | equivalent | ntu | % | % |
| Blank | 0 | 0 | 0 | 0 | 455 | 0 | N/A |
| Benchmark | 1.00 | 1.00 | 0 | 1.00 | 116 | 75 | N/A |
| Regenerated | 0 | 0 | 0.97 | 0.95 | 123 | 73 | 103 |

### Example 9

This example demonstrates the stabilization and filtration performance of a mixture comprising silica stabilization media and diatomite filtration media regenerated from a beer spent cake comprising silica xerogel and straight calcined diatomite. The mixture also included a small amount of new silica xerogel stabilization media to compensate for the lower content of silica xerogel in the regenerated media due to dilution by diatomite precoat that did not include silica xerogel. A 4-liter laboratory-brewed ale was split into two equal samples. One split, used in the benchmark run, was stabilized and filtered in a bench scale pressure filter at 30 ml/min, using 1.00 g Celatom® FP-3 as precoat and Britesorb® D300 and Celatom® FP-3 as body-feed at 1.00 and 1.25 g/L, respectively. The other split was tested under the same conditions with regenerated media (produced from a prior stabilization and filtration test using the same new filtration and stabilization media). The regenerated media had a silica xerogel to diatomite ratio of 1:1.4, contained 0.42 g/g or 42 wt % Britesorb® D300 equivalent silica xerogel and 5.7% LOI. In the test using the regenerated media, 1.00 g new Celatom® FP-3 was used in precoat, and 2.10 g/L of the regenerated media was used as body-feed, plus 0.10 g/L of new Britesorb® D300 (new media adjustment) to raise the silica xerogel to diatomite ratio back to 1:1.25 as prescribed. The experimental conditions and the test results are listed in Table VII. The combination of the regenerated media and the new media adjustment produced a filtrate with clarity and EBC alcohol chill haze similar to those produced using the new media, demonstrating a Regeneration Efficiency of 100%. Filtration pressure slope of the run with the regenerated media was only about 62% of that of the benchmark run, indicating the potential capability of the combination of regenerated media and the new media adjustment to provide for a much longer filtration cycle time.

TABLE VII
Stabilization and Filtration Using Regenerated Silica Xerogel
and Straight Calcined Diatomite

| | Body-feed, g/L | | | | Filtration | | Stabilization | | |
|---|---|---|---|---|---|---|---|---|---|
| | | | | Total | mbar/ | ntu @ | ACH | ACHR | ARE |
| Test | FP-3 | D300 | Regenerated | xerogel | min | 0° C. | ntu | % | % |
| Blank | N/A | N/A | N/A | N/A | N/A | 85 | 118 | N/A | N/A |
| Benchmark | 1.25 | 1.00 | 0 | 1.00 | 53 | 4.4 | 9.0 | 92 | N/A |
| Regenerated* | 0 | 0.10 | 2.10 | 0.98 | 33 | 6.4 | 9.3 | 92 | 102 |

*combination of regenerated media and new media adjustment

### Example 10

This example demonstrates the stabilization and filtration performance of stabilization and filtration media regenerated from a beer spent cake comprising silica xerogel and flux-calcined diatomite. A small amount, as shown in table below, of new silica xerogel stabilization media (new media adjustment) was added to the regenerated media to rebalance the ratio between silica xerogel and diatomite. A 6-liter laboratory-brewed ale was divided into two equal splits, and one was used in the benchmark run. It was stabilized and filtered in a bench scale pressure filter at 40 ml/min using Britesorb® D300 and Celatom® FW-14, a flux-calcined diatomite, as body-feed in the 1:1 ratio. Due to the pressure limitation, the test was run in two subtests of 1.5-liter, each using 1.00 g Celatom® FW-14 as precoat. After drying and dispersion, the spent cake from this test was regenerated by heating at 1300° F. (704° C.) for 30 minutes in a muffle furnace, and the regenerated material had a silica xerogel to diatomite ratio of 3:5 (including two precoats), 0.39 g/g or 39 wt % Britesorb® D300 equivalent silica xerogel and 2.1% LOI. It was used to treat the other beer split at a dosage of 1.55 g/L under the same conditions. The filtration test was run in two equal subtests, each with 1.00 g Celatom® FW-14 as precoat. New Britesorb® D300 of 0.41 g/L (new media adjustment) was added to the body-feed to raise the ratio of silica xerogel to diatomite to 1:1 as prescribed. The experimental conditions and the test results are listed in Table VIII. The combination of regenerated media and the new media adjustment produced a filtrate with clarity and EBC alcohol chill haze similar to those produced with the new media, demonstrating a regeneration efficiency of 100%. The filtration pressure slope of the run with the regenerated media was only about 64% of that of the benchmark run, indicating the that the combination of regenerated media and the new media adjustment is likely to provide for a longer filtration cycle time.

TABLE VIII
Stabilization-Filtration Using Regenerated Silica Xerogel and Flux-calcined Diatomite

| | Body-feed, g/L | | | | Filtration | | Stabilization | | |
|---|---|---|---|---|---|---|---|---|---|
| | | | | Total | mbar/ | ntu @ | ACH | ACHR | ARE |
| Test | FW-14 | D300 | Regenerated | xerogel | min | 0° C. | ntu | % | % |
| Blank | N/A | N/A | N/A | N/A | N/A | 78 | 120 | N/A | N/A |
| Benchmark | 1.00 | 1.00 | 0 | 1.00 | 76 | 4.8 | 10.3 | 91 | N/A |
| Regenerated* | 0 | 0.41 | 1.55 | 1.01 | 49 | 6.3 | 9.2 | 92 | 100 |

*combination of regenerated media and new media adjustment

### Example 11

This example demonstrates the stabilization and filtration performance of a filtration and stabilization media regenerated from a beer spent cake comprising silica xerogel and expanded and milled perlite. A 4-liter laboratory-brewed ale was divided into two equal splits, and one split was used in the benchmark run. It was stabilized and filtered in a bench scale pressure filter at 30 ml/min, using 0.60 g Celatom® CP-600P, an expanded and milled perlite, as precoat and Britesorb® D300 and Celatom® CP-600P as body-feed in the 1:1 ratio by weight. After drying and dispersion, the spent filter cake was regenerated by heating at 1300° F. (704° C.) for 30 minutes in a muffle furnace. The regenerated media had a silica xerogel to perlite ratio of 1:1.4, contained 0.44 g/g or 44 wt % Britesorb® D300 equivalent silica xerogel and 0.6% LOI. The second beer split was treated with the regenerated media as body-feed, supplemented with 0.22 g/L of Britesorb® D300 (new media adjustment) to increase the silica xerogel to perlite ratio to 1:1 as prescribed, and using 0.60 g Celatom® CP-600P as precoat, with the rest of conditions the same as the benchmark test. The experimental conditions and the test results are listed in Table IX. The combination of regenerated media and the new media adjustment produced a filtrate of slightly lower clarity (higher turbidity) at 41% of the pressure slope of the benchmark. A little more dispersion during regeneration to produce a slightly less permeable product would be expected to increase filtrate clarity without a pressure increase higher than that of the benchmark run. EBC alcohol chill haze of the filtrate from the regenerated run was similar to the benchmark run. Both produced about 91% alcohol chill haze reduction, with the regenerated run showing a 99% regeneration efficiency.

TABLE IX
Stabilization and Filtration Using Regenerated Silica Xerogel and Expanded
Perlite.

| | Body-feed, g/L | | | | Filtration | | Stabilization | | |
|---|---|---|---|---|---|---|---|---|---|
| | | | | Total | mbar/ | ntu @ | ACH | ACHR | ARE |
| Test | CP-600P | D300 | Regenerated | xerogel | min | 0° C. | ntu | % | % |
| Blank | N/A | N/A | N/A | N/A | N/A | 120 | 200 | N/A | N/A |
| Benchmark | 0.75 | 0.75 | 0 | 0.75 | 44 | 7.5 | 17.4 | 91 | N/A |
| Regenerated* | 0 | 0.22 | 1.22 | 0.76 | 18 | 11.5 | 18.9 | 91 | 99 |

*combination of regenerated media and new media adjustment

### Example 12

This example demonstrates the stabilization and filtration performance of a media regenerated from a beer spent cake containing Celite Cynergy®. Celite Cynergy is a stabilizing-filtration media of modified diatomite. The modified diatomite stabilizing-filtration media is a composite comprising diatomite filtration media and silica stabilization media. A 4-liter laboratory-brewed ale beer was divided into two equal splits, and one was stabilized and filtered in a bench scale pressure filter using Celite Cynergy at 30 ml/min. After drying and dispersion, the spent cake from this benchmark was regenerated by heating at 1300° F. (704° C.) in a muffle furnace for 30 minutes. The regenerated media had 0.54% LOI vs 1.3% LOI for the new Celite Cynergy. It was used to treat the second beer split under the same conditions. The experimental conditions and the test results are listed in Table X. In both tests, 1.00 g new Celite Cynergy was used in precoat. The regenerated media produced a filtrate with the same clarity and better EBC alcohol chill haze at the same rate of pressure increase. A Regeneration Efficiency of 101% was demonstrated.

TABLE X
Stabilization-Filtration by Regenerated Celite Cynergy ®

| | Body-feed, g/L | | Filtration | | Stabilization | | |
|---|---|---|---|---|---|---|---|
| | | Regen- | mbar/ | ntu @ | ACH | ACHR | ARE |
| Test | Cynergy ® | erated | min | 0° C. | ntu | % | % |
| Blank | N/A | N/A | N/A | 79 | 140 | N/A | N/A |
| Benchmark | 4.0 | 0 | 21 | 2.1 | 8.3 | 94 | N/A |
| Regenerated | 0 | 4.0 | 20 | 2.0 | 6.4 | 96 | 101 |

### Example 13

This is an example of regenerating a commercial beer spent cake comprising stabilization and filtration media. The spent cake sample was generated from processing an Indian pale ale and comprised Britesorb® XLC silica xerogel (silica stabilization media) and Celatom® FW-12 diatomite (filtration media) in a ratio of 4 to 25 by weight. The media used in the process, Britesorb® XLC and Celatom® FW-12 had 7.8% and 0.4% LOI, respectively. The whole batch of the spent cake was collected, dewatered by pressure filtration, dried and then dispersed through a hammer mill with an open discharge. The dispersed spent cake was sieved through a 100 mesh screen to remove a small amount of coarse particles. The processed spent cake had 11.2% LOI.

Small samples of the spent cake were tested for regeneration by heating in a muffle furnace at 1300° F. (704° C.) in a cold or preheated ceramic tray at various batch loadings for varying durations. Properties of the regenerated media are listed in Table XI, showing varying permeability, wet bulk density and LOI. The regenerated media were tested for stabilization effectiveness in a commercial dark pale ale against the new media (benchmarks) at the same dosages and the results are listed in Table XII. All regenerated media had alcohol chill haze reduction within ±20% of the new media (benchmarks). It should be noted that, adjusted for lower LOIs in the regenerated media, the equivalent silica xerogel dosages in the tests using the regenerated media were about 20% higher than those of the benchmarks. After factoring in the difference in equivalent dosage of silica xerogel used, the regeneration efficiency was calculated to be between 70-102%. At 1300° F. (704° C.), heating for 10 minutes in a hot tray produced the best regeneration efficiency (sample 22-6) for this spent cake.

TABLE XI
India Pale Ale Spent Cake Regeneration at 704° C.

| Regeneration Test | 22-5 | 22-8 | 22-4 | 22-6 | 22-7 | 22-9 | 22-10 |
|---|---|---|---|---|---|---|---|
| Tray | Cold | Cold | Hot | Hot | Hot | Hot | Hot |
| g/batch | 97 | 50 | 200 | 99 | 50 | 50 | 30 |
| min | 15 | 5 | 30 | 10 | 5 | 2 | 1.5 |

Regenerated media

| Permeability, | | 0.91 | 0.69 | 1.56 | 1.26 | 1.17 | 1.12 | 1.06 |
|---|---|---|---|---|---|---|---|---|
| Darcy | | | | | | | | |
| Wet Bulk | lbs/ft³ | 21.1 | 21.1 | 18.1 | 19.3 | 19.8 | 19.9 | 20.4 |
| Density | g/cm³ | 0.34 | 0.34 | 0.29 | 0.31 | 0.32 | 0.32 | 0.33 |

| | | | | | | | |
|---|---|---|---|---|---|---|---|
| LOI, % | 0.57 | 1.00 | 0.22 | 0.51 | 0.36 | 0.48 | 0.69 |

TABLE XII
Stabilization of Dark Pale Ale by Regenerated Media

| | Test 1: Beer - 110 ntu @ 5° C. | | | | | Test-2: Beer - 88 ntu @ 5° C. | | | | | |
|---|---|---|---|---|---|---|---|---|---|---|---|
| Stabilization | | Bench | | | | | Bench | | | | |
| Media | Blank | mark | 22-4 | 22-5 | 22-6 | Blank | mark | 22-7 | 22-8 | 22-9 | 22-10 |
| FW-12, g/L | 0 | 3.00 | 0 | 0 | 0 | 0 | 3.00 | 0 | 0 | 0 | 0 |
| XLC, g/L | 0 | 0.50 | 0 | 0 | 0 | 0 | 0.50 | 0 | 0 | 0 | 0 |
| Regenerated, g/L | 0 | 0 | 3.50 | 3.50 | 3.50 | 0 | 0 | 3.50 | 3.50 | 3.50 | 3.50 |
| Xerogel eq., g/L | 0 | 0.50 | 0.61 | 0.60 | 0.60 | 0 | 0.50 | 0.61 | 0.60 | 0.60 | 0.60 |
| ACH, ntu | 210 | 110 | 120 | 101 | 87 | 205 | 83 | 92 | 74 | 95 | 102 |
| ACHR, % | 0 | 48 | 43 | 52 | 59 | 0 | 60 | 55 | 64 | 54 | 50 |
| ARE, % | N/A | N/A | 74 | 90 | 102 | N/A | N/A | 77 | 89 | 75 | 70 |

### Example 14

A few regenerated media of Example 13 were tested for stabilization effectiveness and filtration performance in a dark pale ale that had not been stabilized or filtered against a mixture of new media (benchmark), i.e., Britesorb® XLC silica xerogel (silica stabilization media) and Celatom® FW-12 diatomite (filtration media). The Celatom® FW-12 diatomite used in this test had 0.73 Darcy permeability and 20.9 lbs/ft³ (0.33 g/cm³) wet bulk density. The same Celatom® FW-12 was used in precoat at 1.00 g per batch. The raw beer had a turbidity of 32-40 ntu at 5° C. and 240-250 ntu EBC alcohol chill haze. Each test processed 2 L of the beer at a constant flow rate of 40 ml/min. The test conditions and results are listed in Table XIII. The beers treated with the regenerated media, after stabilization and filtration, had turbidities (at 0° C.) that were 20-45% lower than that of the benchmark filtrate. EBC alcohol chill hazes of the beers processed with the regenerated media were within a ±6% of the benchmark filtrate. The pressure slopes of the tests using the regenerated media were only about 20-55% of that of the benchmark test. It should be noted that the comparative tests were carried out under the basis of equal weight of body-feed media. Changes in LOIs of the media made difference in the actual usage of each component. With these corrections, the regenerated media runs used 5% more Celatom® FW-12 equivalent and 20% less silica xerogel equivalent relative to the benchmark. Based on the equivalent silica gel dosage, the regenerated media had 103-138% regeneration efficiency as determined by stabilization of this beer.

TABLE XIII
Stabilization-Filtration of Dark Pale Ale by Regenerated Media

| | Body-feed, g/L | | | | | Filtration | | Stabilization | | |
|---|---|---|---|---|---|---|---|---|---|---|
| | | | Regen- | FW-12 | BS XLC | mbar/ | ntu @ | ACH | ACHR | ARE |
| Test | FW-12 | BS XLC | erated | equiv.* | equiv.* | min | 0° C. | ntu | % | % |
| Blank | N/A | N/A | N/A | N/A | N/A | N/A | 87-102 | 240-250 | N/A | N/A |
| Benchmark | 1.20 | 0.25 | 0 | 1.20 | 0.25 | 9.5 | 19.2 | 150 | 40 | N/A |
| 22-5 | 0 | 0 | 1.45 | 1.26 | 0.20 | 3.1 | 10.5 | 140 | 44 | 138 |
| 22-6 | 0 | 0 | 1.45 | 1.26 | 0.20 | 1.9 | 15.5 | 160 | 33 | 103 |
| 22-8 | 0 | 0 | 1.45 | 1.26 | 0.20 | 5.2 | 11.4 | 158 | 34 | 106 |

*Adjusted for LOI in new and regenerated media.

### Example 15

A beer spent cake was collected from a German brewery. In the stabilization and filtration cycle the spent cake was formed, and a total of 37 kg of flux-calcined diatomite Celatom® FW-14, 150 kg of straight calcined diatomite Celatom® FP-3, 43 kg of silica xerogel Becosorb® 1000 and 3 kg of PVPP were used to process 971 hL of beer. The spent cake therefore contained silica xerogel and diatomite in a ratio of about 1:4 by weight. The spent cake was dewatered, dried and dispersed through a hammer mill. The resulting powder had about 14% LOI.

The dried and dispersed spent cake was run through the regeneration process of the current disclosure in a laboratory rotary electrical tube furnace made by Sentro Tech Corp., model STTR-1500C-3-024, equipped with a 3″ (76 mm) internal diameter high temperature alloy steel tube, with a hot zone length of 24″ (610 mm). The tube was tilted to an 11% slope and operated at 4.5 rpm. A knocking device was added to assist in dislodging material from the wall of the heated tube. The dried and dispersed spent cake was fed to the tube continuously with a volumetric feeder at a rate of 9.5 g/min, and the regenerated product was collected at the discharge end of the tube. The regeneration process was tested at temperatures of 1300 and 1350° F. (704 and 732° C.). The regenerated products were characterized by permeability, wet bulk density. LOI and specific surface area (Table XIV), and are compared to a mixture of Becosorb® 1000 and Celatom® FP-3. They were also tested for stabilizing a commercial Belgian tripel against a mixture of Becosorb® 1000 and Celatom® FP-3 at 1:4 by weight. The regenerated media performed as well as or slightly better than the benchmark in stabilizing a 120 ntu (at 5° C.) unstabilized Belgian tripel at a dosage of 2.5 g/L, unadjusted for LOI, showing regeneration efficiencies of 99-106%.

TABLE XIV
Rotary Tube Furnace Regeneration of German Beer Spent Cake

| | Regeneration | | New or Regenerated Media | | | | |
|---|---|---|---|---|---|---|---|
| | | | | | | | Surface |
| | | | Perm. | WBD | WBD | LOI | area, |
| Test | ° F. | ° C. | mDarcy | lbs/ft³ | g/cm³ | % | m²/g |
| Becosorb ® 1000 | N/A | N/A | 51 | 24.7 | 0.40 | 11.8 | 288 |
| Celatom ® FP-3 | N/A | N/A | 227 | 22.8 | 0.37 | 0.5 | 2.2 |
| Benchmark* | N/A | N/A | 141 | 24.0 | 0.38 | 3.3 | 59 |
| Regenerated-1 | 1300 | 704 | 188 | 22.9 | 0.37 | 1.9 | 61 |
| Regenerated-2 | 1350 | 732 | 208 | 22.5 | 0.36 | 0.5 | 50 |

*A mixture of Becosorh ® 1000 and Celatom ® FP-3 at 1:4 by weight, calculated LOI and specific surface area from component values.

TABLE XV
Belgian Tripel Stabilization by Rotary Furnace Regenerated Media

| | Media, g/L | | | | Stabilization | | |
|---|---|---|---|---|---|---|---|
| | Becosorb ® | Celatom ® | Regen- | Xerogel | ACH | ACHR | ARE |
| Test | 1000 | FP-3 | erated | Equivalent | ntu | % | % |
| Blank | 0 | 0 | 0 | 0 | 146 | 0 | N/A |
| Benchmark | 0.50 | 2.00 | 0 | 0.50 | 66 | 55 | N/A |
| Regenerated-1 | 0 | 0 | 2.50 | 0.56 | 58 | 61 | 99 |
| Regenerated-2 | 0 | 0 | 2.50 | 0.56 | 51 | 65 | 106 |

Regeneration Efficiencies of the spent media for stabilizing beers listed in above examples are summarized in Table XVI. The silica stabilization media include silica xerogel, hydrated or hydrous gel, and hydrogel. Modified diatomite stabilizing filtration media is also included in the results. The regenerated media are either silica gel or comprise silica gel and filtration media (diatomite or expanded perlite). The beers tested included varieties of ale and a lager. The Regeneration Efficiency in these examples varied from 55 to about 140%.

TABLE XVI
Regeneration Efficiency for Beer Stabilization - Summary

| | | | | | Stabilization | |
|---|---|---|---|---|---|---|
| | Silica gel | | Filtration | Media Ratio | | RE or |
| Example | Type | Grade* | Media | Stabilization:Filtration | Beer | ARE % |
| 2, 3 | Xerogel | BS D300 | | | Ale | 76-107 |
| 4 | Xerogel | BS D300 | | | Lager | 101 |
| 5 | Xerogel | DRC 1015 | | | Tripel | 104-114 |
| 6 | Hydrated | BCS 2500 | | | Pale Ale | 97 |
| 7 | Hydrogel | DRC 920 | | | Pale Ale | 55 |
| 8 | Xerogel | BS D300 | Calcined DE | 1:1 | Ale | 103 |
| 9 | Xerogel | BS D300 | Calcined DE | 4:5 | Ale | 102 |
| 10 | Xerogel | BS D300 | Fluxed DE | 1:1 | Ale | 102 |
| 11 | Xerogel | BS D300 | Exp'd Perlite | 1:1 | Ale | 99 |
| 12 | Modified DE | Cynergy | Modified DE | N/A | Ale | 101 |
| 13, 14 | Xerogel | BS XLC | Fluxed DE | 4:25 | IPA | 70-138 |
| 15 | Xerogel | BCS 1000 | Calcined DE | 1:4 | Tripel | 99-106 |

*BS - Britesorb ®; DRC - Daraclar ®; BCS - Becosorb ®.

### Example 17

Spent cakes which had previously been regenerated and evaluated (in Examples 9, 10 and 11) were again regenerated by the same method. Listed in Table XVII are certain properties of these twice regenerated materials, as compared to new media and their mixtures of the same ratios. It can be seen that the resulting combination of regenerated media and new media adjustment (as per the method of Examples 9, 10 and 11) has higher permeability than and similar wet bulk density as the corresponding mixtures of new media. The higher permeability explains the lower pressure increase during filtration, and similar wet bulk density indicates good integrity of the particles enduring the regeneration process. Specific surface area of the resulting combination (of regenerated media and new media adjustment as per the method of Examples 9, 10 and 11) similar to the new media indicates retained pore structure of silica xerogel stabilization media and inorganic filter media. Also shown are the significantly reduced solubilities of arsenic, aluminum and iron in the combination (of regenerated media and new media adjustment) as compared to the corresponding mixtures of the same compositions. This indicates that these soluble elements are mostly dissolved during the first use of the media, and subsequent filtration cycles using mostly the regenerated media cause much less metal and arsenic dissolution into beer, which is sometimes beneficial for beer stability and flavor.

TABLE XVII
Properties of 2-Time. Regenerated Media vs. New Media

| | | | | Surface | | | |
|---|---|---|---|---|---|---|---|
| | | Perm. | WBD | Area | EBC Solubility, ppm* | | |
| Sample and Composition | Ex. no. | mD | g/cm³ | m²/g | As | Al | Fe |
| Britesorb ® D300 | n/a | 28 | 0.33 | 298 | <0.1 | 1.5 | 0.5 |
| Celatom ® FP-3 | n/a | 227 | 0.37 | 2.2 | 3 | 43 | 69 |
| Celatom ® FW-14 | n/a | 1240 | 0.34 | 0.68 | 1 | 23 | 78 |
| Celatom ® CP-600P | n/a | 613 | 0.20 | 1.3 | 0.5 | 133 | 37 |
| Mix: FP-3/D300 (65/35) | n/a | 116 | 0.36 | 106 | 2 | 28 | 45 |
| Regenerated: FP-3/D300 (65/35) | 9 | 142 | 0.36 | 94 | 0.1 | 8 | 19 |
| Mix: FP-3/D300 (63/37) | n/a | 243 | 0.38 | 111 | 0.7 | 15 | 49 |
| Regenerated: FW-14/D300 (63/37) | 10 | 409 | 0.38 | 111 | 0.2 | 5 | 15 |
| Mix: CP-600P/D300 (58/42) | n/a | 295 | 0.27 | 126 | 0.3 | 78 | 22 |
| Regenerated: CP-600P/D300 (58/42) | 11 | n/a | n/a | n/a | 0.1 | 26 | 16 |

*Calculated values for mixtures of new media determined using the EBC Extraction Method.

### Example 18

This example demonstrates how permeability of a regenerated media can be adjusted by mixing with a new media to meet the requirement of filtration performance. A regenerated product comprising diatomite Celatom® FP-3 (filtration media) and silica xerogel Becosorb® 1000 (silica stabilization media) in a ratio of 4:25 (Example 13. Sample 22-4 in Table XI) had a much higher permeability as compared to a mixture of the same new media in the same ratio. A fine natural diatomite of 0.8 mDarcy permeability and 32.9 lbs/ft³ (0.53 g/cm³) wet bulk density was mixed with the regenerated product. Through this procedure, the permeabilities of the mixtures comprising regenerated media were reduced and closely matched that of the level of the mixture of new media (Table XVIII) when the natural diatomite additive comprised 10% of the regenerated media.

TABLE XVIII
Permeability Adjustment of Regenerated Media

| | Fine DE | Permeability | WBD |
|---|---|---|---|
| Sample | Addition, % | Darcy | g/cm³ |
| Regenerated Media | 0 | 1.56 | 0.29 |
| Regenerated Media | 5 | 1.04 | 0.31 |
| Regenerated Media | 10 | 0.48 | 0.33 |
| Mix: BCS1000/FP-3 = 4/25 | 0 | 0.51 | 0.33 |

### Example 19

A flux-calcined diatomite, Celatom® FW-12, lot 2D12F6, made from selected ores using special formulations, was determined to contain about 4% opal-C, no cristobalite and <0.1% quartz or a total content of crystalline silica of <1% by the method of PCT/US16/37830. PCT/US16/37816 and PCT/US16/37826, each by Lenz et al., described below.

Per Lenz et al. (PCT/US16/37830, PCT/US16/37816 and PCT/US16/37826), one relatively simple way to confirm the absence of cristobalite within a sample is to spike the sample (add a known amount of) with cristobalite standard reference material (i.e. National Institute of Standards and Technology (NIST) Standard Reference Material 1879A), run XRD analysis on the spiked sample and then compare the original un-spiked sample diffraction pattern with the spiked sample pattern. If the spiked sample diffraction pattern simply increases the intensity of the primary and secondary peaks but does not show a position shift or show additional peaks, then the original sample most likely contains cristobalite. If the primary peak shifts and becomes sharper (or resolves into two separate peaks), and secondary peaks appear or become much better defined, then opal-C (and/or opal-CT) and not cristobalite is present in the original sample.

To determine whether a sample of a product that includes diatomite contains cristobalite or opal-C (and/or opal-CT) and then to quantify the opal-C (and/or opal-CT) and/or crystalline silica content involves a number of steps according to the Improved Method disclosed in Lenz et al. (PCT/US16/37830. PCT/US16/37816 and PCT/US16/37826), and referred to in Lenz et al, as the “LH Method.”

First, it is determined whether the sample contains water of hydration via high temperature loss on ignition testing. For example, a (representative) first portion of the sample is obtained and loss on ignition testing is performed on such first portion.

Second, bulk powder X-ray Diffraction is performed, and the resulting (first) diffraction pattern inspected. For example, preferably, a (representative) second portion of the sample is obtained and bulk powder XRD is performed on the second portion. Preferably, the second portion is milled prior to XRD. The resulting (first) diffraction pattern is analyzed for the presence or absence of opal-C (and/or opal-CT) and cristobalite. The resulting (first) diffraction pattern may also be analyzed for the presence or absence of other crystalline silica phases (for example, quartz and tridymite) within the (representative) second portion of the sample. If the (first) diffraction pattern is obviously indicative of opal-C (or opal-CT), then further analysis is not required to determine whether the sample contains cristobalite or opal-C (and/opal-CT). The opal-C (and/or opal-CT) diffraction pattern differs from that of α-cristobalite in the following ways: the primary peak (22°) and the secondary peak (36°) are at higher d-spacing (lower 20 angle), there is a broader primary peak for opal-C (and/or opal-CT) as measured using the “Full Width at Half Maximum” (FWHM) statistic, opal-C (and/or opal-CT) has poorly-defined peaks at 31.50° and 28.49° 2θ, and a much more significant amorphous background.

If the (first) diffraction pattern is questionable with regard to whether opal-C (and/or opal-CT) and/or cristobalite is present, then according to the LH Method a second XRD analysis is performed to determine whether opal-C (and/or opal-CT) and/or cristobalite is present. This time the analysis is performed on, preferably, another representative portion of the sample spiked with cristobalite standard reference material (NIST 1879a). For example, a (representative) third portion of the sample is obtained and then spiked with cristobalite standard reference material (NIST 1879a) and XRD is performed on the third portion. The resulting (second) diffraction pattern from the XRD on the third portion is analyzed. Preferably, the third portion is milled prior to XRD. If the original sample (for example, the representative second portion of) comprises opal-C (and/or opal-CT), the cristobalite spike significantly modifies the diffraction pattern (from that of the second portion) with additional peaks identifiable at 22.02° and 36.17° 2θ, along with more prominent peaks at 31.50° and 28.49° 2θ seen in the (second) diffraction pattern of the third portion. If the original sample (more specifically, the second portion of) comprises cristobalite, then addition of the cristobalite spike (to the third portion) only results in increased peak intensity and no other significant change from the (first) diffraction pattern of the second portion (as seen in the (second) diffraction pattern of the third portion).

Quantifying the opal-C (and/or opal-CT) content of a diatomite sample can be complicated as its diffraction pattern is a combination of broad peaks and amorphous background, and diatomite products often contain other x-ray amorphous phases in addition to opal. According to the LH Method, an estimate of the quantity is obtained by treating the opal-C (and/or opal-CT) peaks (collectively, if both phases are present) of the first diffraction pattern as if they are cristobalite and quantifying against cristobalite standards such as NIST 1879a. This method of quantification of opal-C (and/or opal-CT), which Lenz et al. (PCT/US16/37830, PCT/US16/37816 and PCT/US16/37826) calls the XRD Method, will usually underestimate the opal-C (and/or opal-CT) content but is effective for a number of purposes, such as manufacturing quality control. For clarity, this XRD Method is part of the umbrella LH Method. Alternatively (under the LH Method), a measure may be obtained by heating a representative portion of the sample (for example, a fourth portion) at very high temperature (e.g., 1050° C.) for an extended period (for example 24 to 48 hours) until that heated portion is fully dehydrated. This completely dehydrates opaline phases and forms cristobalite (reduces amorphous background component). XRD analysis is then performed on the fourth portion and the cristobalite in the resulting (third) diffraction pattern of the fourth portion can be quantified against the cristobalite standards to give an estimate of original opal-C (and/or opal-CT) content. Preferably, the fourth portion is milled prior to XRD. As long as additional flux is not added prior to heating the fourth portion, and the temperature kept below 1400° C., any quartz present in the fourth portion will not be converted to cristobalite.

To obtain the total crystalline silica content wt % of the sample according to the LH Method, the weight percentage of the identified cristobalite (if any), the weight percentage of the quartz (if any) and the weight percentage of tridymite (if any) are added together to calculate the total weight percentage of the crystalline silica content in the sample. To obtain the weight percentage of quartz or tridymite found to be present during the analysis of the (first) diffraction pattern of the second portion of the sample, each of quartz or tridymite may be compared to its respective standard (for example, NIST SRM 1878b for quartz) for quantification of the content, or be quantified through the use of an internal standard (such as corundum) and applicable relative intensity ratios. If it is determined by the LH Method that cristobalite is present, the cristobalite seen in the (first) diffraction pattern of the second portion of the sample, may be compared to its respective standard (for example NIST 1879a) for quantification of the content, or be quantified through the use of an internal standard (such as corundum) and applicable relative intensity ratios. In the unusual case where there is both opal-C (or opal-CT) and cristobalite present and the primary peak of the opal-C (or opal-CT) cannot be differentiated or de-convoluted from that of cristobalite, the opal-C (or opal-CT) and cristobalite are quantified as one phase and reported as cristobalite. The quantity of cristobalite thus reported will be higher than the actual quantity in the sample. Because the sample is a representative sample of the product, the total weight percentage of the crystalline silica content in the sample is considered to accurately represent the total weight percentage of the crystalline silica content in the product from which the sample was taken.

In Lenz et al. (PCT/US16/37830. PCT/US16/37816 and PCT/US16/37826), the bulk powder XRD work detailed was performed using a Siemens® D5000 diffractometer controlled with MDI™ Datascan5 software, with CuKα radiation, sample spinning, graphite monochromator, and scintillation detector. Power settings were at 50 KV and 36 mA, with step size at 0.04° and 4 seconds per step. JADE™ (2010) software was used for analyses of XRD scans. Sample preparation included SPEX® milling in zirconia vials with zirconia grinding media.

Continuing on with the discussion of Example 19, this diatomite filtration media, Celatom® FW-12, lot 2D12F6, was used, together with a silica xerogel. Britesorb® XLC (silica stabilization media), to treat 2 liters of a commercial dark pale ale of 91 ntu turbidity at 5° C., at usages of 1.00 and 0.25 g/L respectively, by mixing in an ice bath shaker for 30 minutes. After the treatment, the spent media was concentrated by centrifugation and then recovered from the beer by vacuum filtration through a 0.45-μm membrane. The filter cake was dried at 120° C. overnight, and the dried spent media was determined to have an LOI of 14%. It was regenerated by heating at 1300° F. (704° C.) in a muffle furnace for 30 minutes. The regenerated media was tested for stabilization effectiveness in a commercial dark pale ale that had not been stabilized or filtered and which had a turbidity of 78 ntu (at 5° C.), against a benchmark containing the same ratio of stabilization and filtration media that was used to generate the spent media. At a usage of 1.25 g/L, the regenerated media reduced the EBC alcohol chill haze of the beer from 230 ntu (blank) to 140 ntu vs 138 ntu for the benchmark. The stabilization capability of the spent media was thus fully regenerated, and the regenerated media contained no cristobalite and <0.1% quartz as analyzed by the same method. This example demonstrates that the thermal regeneration process of this disclosure does not increase the content of crystalline silica in silica spent stabilization and/or filtration media.

### Example 20

Contamination of food or beverage products by micro-organisms can be a significant health risk. As a result, it is important that stabilization and processing media used in food and beverage processing be free of contamination. This is an important consideration for regenerated media which have been previously exposed to food and beverages.

Two samples of regenerated media were sent to Analytical Laboratories in Boise, Id., USA, in order to characterize them for microbiological matter content. To run the microbiological analyses, 225 ml of sterile Butterfield's phosphate buffered dilution water was added to 25 g of each sample (1:10 dilution) and the two was mixed for 30 seconds. For each test a 1-ml aliquot of the suspension was pipetted to a standard agar plate for incubation under required conditions for a set period of time. The total numbers of colonies formed by the end of incubation were counted. All methods had a detection limit of 10 colony-forming unit per gram of a solid sample (CFU/g), or 1 CFU per 1 ml of 1:10 dilution (0.1 g of a sample being analyzed).

The methods used for analyzing molds and yeasts followed the American Public Health Association Method for the Microbiological Examination of Foods (4^{th} Edition). The method described below for both the mold and yeast analyses will be called the method of the American Public Health Association for the Microbiological Examination of Foods or the “APHA MEF Method”. According to the APHA MEF Method used for the molds analyses and for yeasts analyses, chloramphenicol, an antibiotic, was added to the standard agar and the latter was solidified in plate before the sample dilution was pipetted to and spread over, and incubation was carried out in the dark at room temperature at 25° C. (+/−0.5° C.) for five days. The mold and yeast colonies were counted at the end of incubation.

The “Aerobic Plate Count” method of the U.S. Food and Drug Administration Bacteriological Analytical Manual, 8^{th} Edition, was followed for both aerobic and anaerobic plate count analyses. The method described below for the aerobic and anaerobic bacteria analyses is referred to herein as the method of the U.S. Food and Drug Administration Bacteriological Analytical Manual or the “USFDA Method”. If conducted for aerobic bacteria analyses, it may be referred to herein as the USFDA Method for aerobic plate. If conducted for anaerobic bacteria analyses, it may be referred to as the USFDA Method for anaerobic plate. According to the USFDA Method for aerobic plate, the sample dilution was pipetted to and mixed with the standard agar (without chloramphenicol) before it solidified and the set plates were incubated at 35° C. (+/−1° C.) for 48 hours (+/−2 hours) (in atmosphere). The aerobic bacteria colonies were counted at the end of incubation.

The same USFDA Method was adopted for the anaerobic plate analysis, except that the set plate was placed in an anaerobic chamber filled with carbon dioxide. More specifically, the sample dilution was pipetted to and mixed with the standard agar (without chloramphenicol) before it solidified and the set plates were incubated in an anaerobic chamber (filled with carbon dioxide) at 35° C. (+/−1° C.) for 48 hours (+/−2 hours). The anaerobic bacteria colonies were counted at the end of incubation.

The analytical results are listed in Table XIX. On these two samples of regenerated media, according to the analyst, in no case a single colony was observed on the agar growth media that contained a slurry containing 0.1 g of a powder sample being analyzed. The results were reported as <10 CFU/g, which is below the detection limit of the tests methods. In other words, neither regenerated media contained a detectable amount of aerobic or anaerobic bacteria or molds or live yeasts.

TABLE XIX
Reported Microbiological Matter in Regenerated Media

| | Aerobic | Anaerobic | | Live |
|---|---|---|---|---|
| | Plate | Plate | | Yeast |
| | Count | Count | Mold | Cell |
| Sample | CFU/g | CFU/g | CFU/g | CFU/g |
| Rotary furnace regenerated | <10 | <10 | <10 | <10 |
| German ale spent cake | | | | |
| Muffle furnace regenerated | <10 | <10 | <10 | <10 |
| US lager spent cake | | | | |

### INDUSTRIAL APPLICABILITY

The teachings of the present disclosure may be practiced on the industrial scale for regenerating spent media from fluid stabilization and clarification. In particular, the teachings of the present disclosure may be practiced in beer breweries or facilities making other types of fermented beverages in which a silica stabilization media is used to stabilize protein-induced chill haze. According to the process disclosed herein, spent media from stabilization, or stabilization and filtration processes of fermented beverages is heated in an oxidizing environment to form regenerated spent (fermented beverage) media. The thermal treatment removes proteins and other organic matter. Prior to the thermal treatment, the spent media may be collected/accumulated, dewatered by filtration or centrifugation, and dried and dispersed.

In some embodiments, the spent media may be stored prior to thermal treatment (heating for regeneration). Furthermore, prior to the thermal treatment, the spent fermented beverage media may be segregated to obtain spent media for thermal treatment that has a substantially uniform (plus or minus 10%) permeability. In other embodiments, the spent fermented beverage media may be segregated according to wider or narrower permeability range. In some embodiments, prior to the thermal treatment, the spent fermented beverage media may be segregated by stabilization media content or extractable chemistry.

The drying process may be carried out in an industrial oven, a tray drier, a rotary dryer or a flash dryer. The dried material may be dispersed in a controlled gentle milling device such as a milling fan, a hammer mill or a pin mill to avoid over milling, or it may be dispersed through a sieving device such as a centrifugal sifter or combination of a mill and a shifter.

Thermal treatment of the dispersed material may be accomplished in a fluidized furnace or a rotary kiln or in a traveling grate or multiple hearth kiln. The energy sources for the furnaces and kilns may include electricity, natural gas, petroleum or coal. Either conventional electric or dielectric furnaces may be utilized. Oxidizing agents other than oxygen may be added during the heat treatment. A fluidized furnace may provide the necessary oxidation environment, temperature and residence time required to achieve full combustion and removal of organic matter, such as yeast cell debris and adsorbed proteins without degrading pore structure and activity of the silica gel. Fluidized furnaces that may be used for this purpose include flash calciners and perlite expanders. Examples of flash calciners include fluidized bed reactors or flash calciners or roasters marketed by FL Smidth, the Torbed® reactors by Torftech, or catalytic flash calciners by Calix. Examples of perlite expanders that may be used for regenerating spent stabilization and filtration media include the conventional expanders from Silbrico, Incon and others, and the newly developed ones such as the Bublon furnaces from Bublon GmbH and FLLOX expanders from Effective Energy Associates, LLC (now Reaction Jets, LLC). After thermal treatment, the material is cooled, collected and dispersed if necessary for reuse.

In some embodiments, the thermal treatment of the spent media may take place within the same manufacturing location as the filtration process by which the spent fermented beverage media was produced. In other embodiments, the thermal treatment to form regenerated media may take place within a 100 mile radius of the location of the filtration process by which the spent fermented beverage media was produced.

To further reduce the solubility of undesired substances, an acid wash or rinse process may be included before or after thermal regeneration. To reuse the regenerated stabilization and filtration media, any loss during regeneration and imbalance in the ratio between the filtration media and the stabilization media may be supplemented and rebalanced by adding an appropriate amount of new materials, which can also be used to improve the performance of the regenerated media. Filtration performance may be adjusted by the addition of a new filtration media of a different permeability to adjust the permeability of the combined media. In a liquid filtration application, the regenerated stabilization and filtration media can be used as bodyfeed or as both precoat and bodyfeed.

In addition to providing similar beer stabilization and filtration performance to that of new media, the regenerated media of the present disclosure provide for substantially reduced transportation costs, substantially reduced or eliminated purchasing costs, and higher purity (in terms of reduced soluble impurities), all relative to new media, while retaining the robust flexibility of particulate stabilization and filtration media. Such attributes offer potentially significant savings to manufacturers and brewers as well as environmental benefits due to a significant reduction in both the carbon footprint for breweries and the space requirements for the disposal of single-use media in landfills. In addition to these benefits, the process and products described can be produced in both new and regenerated form free of crystalline silica, an important benefit to worker safety in the mining, processing, transportation, beer stabilization and clarification, regeneration and ultimately (after multiple uses) disposal or alternate use of these materials. The improved extractable chemistry of the regenerated media provides for a significant reduction in the impurities introduced into liquids from powdered stabilization (or stabilization and filtration) media. While only certain embodiments have been set forth herein, alternative embodiments and various modifications will be apparent from the above description to those skilled in the art. These and other alternatives are considered equivalents and within the spirit and scope of this disclosure.

1-30. (canceled)

31. A method of preparing a media for re fermented beverages comprising:
heating a spent fermented beverage media in an oxidizing environment to form a regenerated spent fermented beverage media for re-use in stabilization of fermented beverages, wherein the regenerated spent fermented beverage media includes silica stabilization media.

32. The method of claim 31, further comprising dewatering the spent fermented beverage media prior to heating for regeneration.

33. The method of claim 32, further comprising drying the spent fermented beverage media prior to heating for regeneration.

34. The method of claim 31, wherein heating the spent fermented beverage media in an oxidizing atmosphere in a temperature range of about 600° C. to about 800° C.

35. The method of claim 34, wherein the temperature range is about 650° C. to about 750° C.

36. The method of claim 34, wherein heating the spent fermented beverage media occurs for a time period between 30 seconds and 1 hour.

37. The method of claim 31, wherein heating the spent fermented beverage media occurs in an oxidizing environment having a sufficient amount of oxygen to form the regenerated spent fermented beverage media.

38. The method of claim 37, wherein the oxidizing atmosphere is achieved by intimately contacting the spent fermented beverage media with air containing oxygen sufficient to fully oxidize organic matter in the spent fermented beverage media.

39. The method of claim 38, wherein the air, as supplied, contains 15% to 50% oxygen by volume.

40. The method of claim 31, wherein the spent fermented beverage media further comprises an inorganic material other than silica stabilization media.

41. The method of claim 40, wherein the inorganic material is selected from the group consisting of diatomite, perlite, rice hull ash or combinations thereof.

42. The method of claim 31, further comprising adding an oxidizing agent to the spent fermented beverage media during the heating.

43. The method of claim 42, wherein the oxidizing agent is selected from the group consisting of oxygen-enriched air, hydrogen peroxide, ozone, fluorine, chlorine, nitric acid, an alkali nitrate, peroxymonosulfuric acid, peroxydisulfuric acid, an alkali salt of peroxymonosulfuric acid, an alkali salt of peroxydisulfuric acid, an alkali salt of chlorite, alkali salt of chlorate, alkali salt of perchlorate or alkali salt of hypochlorite.

44. The method of claim 31, further comprising adding a stabilization media and to the regenerated spent fermented beverage media to adjust at least one of a stabilization capability of the regenerated spent fermented beverage media, a size exclusion of the regenerated spent fermented beverage media or a permeability of the regenerated spent fermented beverage media.

45. The method of claim 31, further comprising adding a filtration media to the regenerated spent fermented beverage media to adjust at least one of a stabilization capability of the regenerated spent fermented beverage media, a size exclusion of the regenerated spent fermented beverage media or a permeability of the regenerated spent fermented beverage media.

46. The method of claim 31, wherein the silica stabilization media is selected from the group consisting of silica xerogel, silica hydrogel, hydrated silica xerogel or silica hydrous gel.

47. The method of claim 31, further comprising heating the spent fermented beverage media for regeneration of a stabilizing-filtration media.

48. The method of claim 47, wherein the stabilizing-filtration media comprises a modified diatomite stabilizing-filtration media.

49. The method of claim 47, wherein the stabilizing-filtration media comprises Celite Cynergy.

50. The method of claim 31, further comprising:
accumulating spent fermented beverage media;
segregating, prior to the heating, the spent fermented beverage media according to at least one of a permeability range, a stabilization media content or an extractable chemistry; and
storing the spent fermented beverage media prior to regeneration.
